(19) United States
(12) Patent Application Publication
(10) Pub. No.: US 2024/0135402 A1
(43) Pub. Date: Apr. 25, 2024

(54) SYSTEMS, METHODS, AND DEVICES FOR AUTOMATIC DATASET VALUATION

(71) Applicant: Gulp Data, Inc., San Juan, PR (US)

(72) Inventors: Lauren S. Cascio, San Juan, PR (US); Charles E. Fisher, San Juan, PR (US); Christopher M. Ensey, San Juan, PR (US); Michael S. Sobeck, San Juan, PR (US); Michael S. Blake, Caldas da Rainha (PT); Gbolahan Promise Dada, State College, PA (US); Luis A. Obregon Mogollon, Bayamon, PR (US); Rogfel Thompson Martínez, Brasília (BR); Antonio Martin Martinez, Brasilia (BR); Carlos Valenzuela Lembach, Weston, FL (US)

(21) Appl. No.: 18/491,650

(22) Filed: Oct. 19, 2023

Related U.S. Application Data
(60) Provisional application No. 63/581,527, filed on Sep. 8, 2023.
(60) Provisional application No. 63/380,272, filed on Oct. 20, 2022.

(51) Int. Cl. G06Q 30/0201; G06Q 30/0601; H04L 9/08

(52) U.S. Cl. CPC G06Q 30/0206; G06Q 30/0631; H04L 9/0819

(57) ABSTRACT

A method can include establishing, by a computing system, a secure electronic network connection to an electronic agent running configured to access the dataset to dynamically generate the metadata related to the dataset on a client computing system. A method can include receiving, by the computing system, from the electronic agent via the secure electronic network connection, metadata related to a dataset, the metadata comprising a plurality of attributes of the dataset and a summary of the dataset. A method can include applying a valuation model to the metadata to determine an estimated value of the dataset, the valuation model comprising a machine learning model trained using marketplace data comprising sales prices and attributes of one or more datasets, wherein the model is trained to output the sales prices of the one or more datasets. A method can include determining, an estimated value of the dataset.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Patent Application No. 63/380,272, filed Oct. 20, 2022, titled SYSTEMS, METHODS, AND DEVICES FOR AUTOMATIC DATA ASSET VALUATION,” and U.S. Provisional Patent Application No. 63/581,527, filed Sep. 8, 2023, titled “SYSTEMS, METHODS, AND DEVICES FOR AUTOMATIC DATA ASSET VALUATION,” the entire contents of each of which are hereby incorporated by reference herein for all purposes as if set forth fully herein.

### TECHNICAL FIELD

The present application is directed to systems, methods, and devices for automatic dataset valuation. More specifically, in some embodiments, the present application is directed to systems, methods, and devices that use artificial intelligence, machine learning, or both to automatically determine a value of a dataset of an entity. In some embodiments, the systems, methods, and devices herein can be used to enable escrow services, borrowing services, and/or sales services for datasets.

### BACKGROUND

The approaches described in this section are approaches that could be pursued, but not necessarily approaches that have been previously conceived or pursued. Thus, unless otherwise indicated, it should not be assumed that any of the material described in this section qualifies as prior art merely by virtue of its inclusion in this section.

The global volume of data generated is currently doubling every two years, according to analyst firm IDC. Digital technologies create a significant amount of data per human every minute of every day, and the rate of data creation may increase over time. Data can be bought and sold like other goods. However, there are problems with current approaches to valuing, buying, and selling datasets. Accordingly, improved systems and methods are needed.

### SUMMARY

For purposes of this summary, certain aspects, advantages, and novel features are described herein. It is to be understood that not necessarily all such advantages may be achieved in accordance with any particular embodiment. Thus, for example, those skilled in the art will recognize the disclosures herein may be embodied or carried out in a manner that achieves one or more advantages taught herein without necessarily achieving other advantages as may be taught or suggested herein.

A system can allow entities to leverage data in a way that incentivizes growth and reduces fundraising dilution by appropriately valuing their datasets. The system can value and manage datasets of an entity in order to use it to collateralize a loan, to value it for sale, and so forth.

In some aspects, the techniques described herein relate to an electronic agent-based method for analyzing metadata received from an electronic agent operating on a client computing system related to a first dataset, using a machine learning model including: receiving, by the computing system from the electronic agent, metadata related to the first dataset, wherein the electronic agent is configured to access the first dataset to generate the metadata related to the first dataset, the metadata including a plurality of attributes of the first dataset; applying, by the computing system, a valuation model to the received metadata, wherein the valuation model includes a machine learning model that is trained using marketplace data, the marketplace data including sales prices of one or more datasets and attributes of one or more datasets, wherein the attributes are used to provide inputs to the machine learning model, and wherein the machine learning model is trained to output the sales prices of the one or more datasets; and determining, by the computing system based on the applying the valuation model, an estimated value of the first dataset.

In some aspects, the techniques described herein relate to an electronic agent-based method for analyzing metadata received from an electronic agent operating on a client computing system related to a first dataset, using a machine learning model including: receiving, by the computing system from the electronic agent, metadata related to the first dataset, wherein the electronic agent is configured to access the first dataset to generate the metadata related to the first dataset; applying, by the computing system, a valuation model to the received metadata, wherein the valuation model includes a machine learning model that is trained using marketplace data, the marketplace data including sales prices of one or more datasets and metadata of one or more datasets, wherein the metadata of the one or more datasets is used to provide inputs to the machine learning model, and wherein the machine learning model is trained to output the sales prices of the one or more datasets; and determining, by the computing system based on the applying the valuation model, an estimated value of the first dataset.

In some aspects, the techniques described herein relate to an electronic agent-based computer system method for analyzing metadata received from an electronic agent operating on a client computing system related to a first dataset accessible by the client computing system, using a machine learning model including: establishing, by a computing system, a secure electronic network connection to the electronic agent running on the client computing system; receiving, by the computing system, from the electronic agent operating on the client computing system via the secure electronic network connection, metadata related to the first dataset, wherein the electronic agent is configured to access the first dataset to dynamically generate the metadata related to the first dataset, the metadata including a plurality of attributes of the first dataset and a summary of the first dataset; applying, by the computing system, a valuation model to the received metadata, wherein the valuation model includes a machine learning model that is trained using marketplace data, the marketplace data including sales prices of one or more datasets and attributes of one or more datasets, wherein the attributes are used to provide inputs to the machine learning model, and wherein the machine learning model is trained to output the sales prices of the one or more datasets; and determining, by the computing system based on the applying the valuation model, an estimated value of the first dataset.

In some aspects, the techniques described herein relate to a method, wherein the summary includes at least one of a number of records in the first dataset, a completeness of the first dataset, a uniqueness of records in the first dataset, a growth rate of records in the first dataset, an average number of records associated with each of a plurality of primary keys identified in the first dataset, or an age of the first dataset.

In some aspects, the techniques described herein relate to a method, further including: receiving, by the computing system, a plurality of product ideas from a marketplace, each product idea including a plurality of product attributes; determining, by the computing system, one or more similar attributes in the attributes of the first dataset and the pluralities of product attributes; determining, by the computing system, one or more product recommendations based on the determined one or more similar attributes; and providing, by the computing system, the one or more product recommendations to a client.

In some aspects, the techniques described herein relate to a method, further including: receiving, by the computing system, a plurality of attributes from a marketplace; determining, by the computing system, one or more similar attributes in the attributes of the first dataset and the plurality of attributes from the marketplace; determining, by the computing system, correlations between one of more attributes of the plurality of attributes from the marketplace and the one or more similar attributes; determining, by the computing system based on the correlations, one or more recommended attributes to add to the first dataset; estimating, by the computing system, one or more values of adding one or more recommended attributes to the first dataset; and providing, by the computing system, the one or more recommended attributes and the one or more values to a client.

In some aspects, the techniques described herein relate to a method, further including: estimating, by the computing system, one or more costs of adding the one or more recommended attributes to the first dataset; and providing, by the computing system, the one or more costs to the client.

In some aspects, the techniques described herein relate to a method, further including: applying, by the computing system, a second valuation model to the received metadata, wherein the second valuation model includes a machine learning model that is trained using second marketplace data, the second marketplace data including sales prices of one or more second datasets and attributes of the one or more second datasets, wherein the attributes of the one or more second datasets are used to provide inputs to the second machine learning model, and wherein the second machine learning model is trained to output the sales prices of the one or more second datasets; and determining, by the computing system, a second estimated value of the first dataset based on the applying the second valuation model.

In some aspects, the techniques described herein relate to a method, further including: determining, by the computing system, a reliability of the valuation model.

In some aspects, the techniques described herein relate to a method, further including: receiving, by the computing system, a plurality of attributes from a marketplace associated with a plurality of dataset sales; receiving, by the computing system, a plurality of buyer identifiers associated with the plurality of dataset sales; determining, by the computing system, one or more similar attributes of the first dataset and the plurality of attributes from the marketplace associated with the plurality of dataset sales; determining, by the computing system based on the one or more similar attributes and the plurality of buyer identifiers, one or more recommended buyers of the first dataset; and providing, by the computing system, the one or more recommended buyers to a client.

In some aspects, the techniques described herein relate to a method, further including: receiving, by the computing system, a plurality of attributes from a marketplace associated with a plurality of dataset sales; determining, by the computing system, one or more similar attributes of the first dataset and the plurality of attributes from the marketplace associated with the plurality of dataset sales; grouping, by the computing system, the one or more similar attributes into one or more categories; determining, by the computing system, one or more high significance categories; determining, by the computing system, one or more frequencies of one or more similar attributes; removing, by the computing system, one or more high frequency attributes of the one or more similar attributes; removing, by the computing system, one or more zero frequency attributes of the one or more similar attributes; identifying, by the computing system, one or more scarce attributes, wherein the one or more scarce attributes having greater than zero frequency and less than high frequency.

In some aspects, the techniques described herein relate to a method, further including: providing, by the computing system to a large language model, the attributes of the first dataset; generating, by the computing system using the large language model, a description for each of the attributes of the first dataset; storing, by the computing system, the attributes of the first dataset and the descriptions in a database, wherein in response to a query from a buyer, the computing system is configured to search the database for attributes that match the query and to provide results of the search to the buyer.

In some aspects, the techniques described herein relate to a method, further including: receiving, by the computing system from the agent installed on the client computing system of the client, a copy of the first dataset, wherein the copy is an encrypted copy of the first dataset; and storing the copy of the first dataset.

In some aspects, the techniques described herein relate to a method, further including: receiving, by the computing system from the agent installed on the client computing system of the client, an update to the first dataset, wherein the update to the first dataset includes a delta update.

In some aspects, the techniques described herein relate to a method, further including: receiving, by the computing system, from the electronic agent operating on the client computing system via the secure electronic network connection, an encrypted copy of the first dataset; storing the encrypted copy of the first dataset in a first data store; and storing an encryption key of the encrypted copy in a second data store, the second data store different from the first data store.

In some aspects, the techniques described herein relate to a method, further including: receiving, by the computing system, from the electronic agent operating on the client computing system via the secure electronic network connection, a delta update to the first dataset; determining, by the computing system, a change to the first dataset; evaluating, by the computing system, the change to the first dataset; and determining, by the computing system based on the evaluating, that the change to the first dataset violates one or more criteria.

In some aspects, the techniques described herein relate to an electronic agent-based computer system method for analyzing metadata received from an electronic agent operating on a client computing system related to a first dataset accessible by the client computing system, using a machine learning model including: establishing, by a computing system, a secure electronic network connection to the electronic agent running on the client computing system; receiving, by the computing system, from the electronic agent operating on the client computing system via the secure electronic network connection, metadata related to the first dataset, wherein the electronic agent is configured to access the first dataset to dynamically generate the metadata related to the first dataset, the metadata including a plurality of attributes of the first dataset and a summary of the first dataset; applying, by the computing system, a first valuation model to the received metadata, wherein the first valuation model includes a first machine learning model that is trained using marketplace data, the marketplace data including sales prices of one or more datasets and metadata of one or more datasets, wherein a first subset of the metadata is used to provide first inputs to the first machine learning model, and wherein the first machine learning model is trained to output a first price metric of the one or more datasets; applying, by the computing system, a second valuation model to the received metadata, wherein the second valuation model includes a second machine learning model different from the first machine learning model that is trained using a second subset of the metadata to provide second inputs to the second machine learning model, and wherein the second machine learning model is trained to output a second price metric of the one or more datasets; determining, by the computing system, a value of the first dataset based at least in part on the first price metric and the second price metric.

In some aspects, the techniques described herein relate to a computing system for analyzing metadata, received from an electronic agent operating on a client computing system, related to a first dataset accessible by the client computing system, using a machine learning model, the computing system including: a processor; and a non-volatile memory having instructions embodied thereon that, when executed by the processor, cause the computing system to perform a method including: establishing, by the computing system, a secure electronic network connection to the electronic agent operating on the client computing system; receiving, by the computing system, from the electronic agent operating on the client computing system via the secure electronic network connection, metadata related to the first dataset, wherein the electronic agent is configured to access the first dataset to dynamically generate the metadata related to the first dataset, the metadata including a plurality of attributes of the first dataset and a summary of the first dataset; applying, by the computing system, a valuation model to the received metadata, wherein the valuation model includes a machine learning model that is trained using marketplace data, the marketplace data including sales prices of one or more datasets and attributes of one or more datasets, wherein the attributes are used to provide inputs to the machine learning model, and wherein the machine learning model is trained to output the sales prices of the one or more datasets; and determining, by the computing system based on the applying the valuation model, an estimated value of the first dataset.

In some aspects, the techniques described herein relate to a computing system, wherein the summary includes at least one of a number of records in the first dataset, a completeness of the first dataset, a uniqueness of records in the first dataset, a growth rate of records in the first dataset, an average number of records associated with each of a plurality of primary keys identified in the first dataset, or an age of the first dataset.

In some aspects, the techniques described herein relate to a computing system, wherein the method executed by the processor further includes: receiving a plurality of product ideas from a marketplace, each product idea including a plurality of product attributes; determining one or more similar attributes in the attributes of the first dataset and the pluralities of product attributes; determining one or more product recommendations based on the determined one or more similar attributes; and providing the one or more product recommendations to a client.

In some aspects, the techniques described herein relate to a computing system, wherein the method executed by the processor further includes: receiving a plurality of attributes from a marketplace; determining one or more similar attributes in the attributes of the first dataset and the plurality of attributes from the marketplace; determining correlations between one of more attributes of the plurality of attributes from the marketplace and the one or more similar attributes; determining, based on the correlations, one or more recommended attributes to add to the first dataset; estimating one or more values of adding one or more recommended attributes to the first dataset; and providing the one or more recommended attributes and the one or more values to a client.

In some aspects, the techniques described herein relate to a computing system, wherein the method executed by the processor further includes: receiving a plurality of attributes from a marketplace associated with a plurality of dataset sales; receiving a plurality of buyer identifiers associated with the plurality of dataset sales; determining one or more similar attributes of the first dataset and the plurality of attributes from the marketplace associated with the plurality of dataset sales; determining, based on the one or more similar attributes and the plurality of buyer identifiers, one or more recommended buyers of the first dataset; and providing the one or more recommended buyers to a client.

In some aspects, the techniques described herein relate to a computing system, wherein the method executed by the processor further includes: receiving a plurality of attributes from a marketplace associated with a plurality of dataset sales; determining one or more similar attributes of the first dataset and the plurality of attributes from the marketplace associated with the plurality of dataset sales; grouping the one or more similar attributes into one or more categories; determining one or more high significance categories; determining one or more frequencies of one or more similar attributes; removing one or more high frequency attributes of the one or more similar attributes; removing one or more zero frequency attributes of the one or more similar attributes; identifying one or more scarce attributes, wherein the one or more scarce attributes having greater than zero frequency and less than high frequency.

In some aspects, the techniques described herein relate to a computing system, wherein the method executed by the processor further includes: providing, to a large language model, the attributes of the first dataset; generating, using the large language model, a description for each of the attributes of the first dataset; storing the attributes of the first dataset and the descriptions in a database, wherein in response to a query from a buyer, the computing system is configured to search the database for attributes that match the query and to provide results of the search to the buyer.

In some aspects, the techniques described herein relate to a computing system, wherein the method executed by the processor further includes: receiving, by the computing system from the agent installed on the client computing system of the client, a copy of the first dataset, wherein the copy is an encrypted copy of the first dataset; and storing the copy of the first dataset.

In some aspects, the techniques described herein relate to a computing system, wherein the method executed by the processor further includes: receiving, by the computing system from the agent installed on the client computing system of the client, an update to the first dataset, wherein the update to the first dataset includes a delta update.

In some aspects, the techniques described herein relate to a computing system, wherein the method executed by the processor further includes: receiving, by the computing system, from the electronic agent operating on the client computing system via the secure electronic network connection, an encrypted copy of the first dataset; storing the encrypted copy of the first dataset in a first data store; and storing an encryption key of the encrypted copy in a second data store, the second data store different from the first data store.

All of the embodiments described herein are intended to be within the scope of the present disclosure. These and other embodiments will be readily apparent to those skilled in the art from the following detailed description, having reference to the attached figures. The invention is not intended to be limited to any particular disclosed embodiment or embodiments.

### BRIEF DESCRIPTION OF THE DRAWINGS

These and other features, aspects, and advantages of the disclosure are described with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 provides an overview of data valuation processes and associated offerings according to some embodiments.

FIG. 2 illustrates an example process for selling data on a platform according to some embodiments.

FIG. 3 illustrates an example data valuation process according to some embodiments.

FIG. 4 illustrates an example process for estimating a value for a dataset according to some embodiments.

FIG. 5 is a flowchart that illustrates an example data value process according to some embodiments.

FIG. 6 shows an example of a normal distribution of value scores according to some embodiments.

FIG. 7 illustrates an example user interface according to some embodiments.

FIG. 8 illustrates an example report according to some embodiments.

FIG. 9 is a flow chart that illustrates an example subscoring process according to some embodiments.

FIG. 10 is a flowchart the illustrates an example process for bundling attributes in a dataset according to some embodiments.

FIG. 11 is a flowchart that illustrates an example process for identifying buyers according to some embodiments.

FIG. 12 illustrates an example process for recommended attributes according to some embodiments.

FIG. 13 illustrates an example of high significance determination according to some embodiments.

FIG. 14 is a flowchart that illustrates an example scarce attribute identification process according to some embodiments.

FIG. 15 is a flowchart that illustrates an example process for determining and applying industry multipliers according to some embodiments.

FIG. 16 is a flowchart that illustrates an example process for determining and applying market multipliers according to some embodiments.

FIG. 17 is a schematic diagram that illustrates various components and information transmission pathways between a customer (also referred to herein as a client) and a valuation service (which could also be a lending service, sales platform, etc.).

FIG. 18 is a flowchart the illustrates an example data integrity check process according to some embodiments.

FIG. 19 is a flowchart that illustrates an example process that can be used to enable natural text searching of datasets.

FIG. 20 depicts a process for training an artificial intelligence or machine learning model according to some embodiments.

FIG. 21 is a block diagram depicting an embodiment of a computer hardware system configured to run software for implementing one or more embodiments disclosed herein.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

The systems and methods described herein can alter how data is utilized within organizations, allowing faster, cheaper, and/or friendlier access to capital. In some embodiments, the systems and methods herein can open new revenue streams by enabling organizations to sell their datasets, or can improve such revenue streams by providing more accurate valuations of datasets. The systems and methods described herein can enable data valuation with reduced effects of impulses, human emotions, and innate biases endemic to traditional funding markets.

The systems and methods herein can be utilized by entities who wish to sell their data, entities who wish to borrow funds and use their data as collateral, or both. For example, some entities may collect data and wish to monetize it by selling access to the data to other entities. However, it can be difficult for entities to determine an appropriate price for their data. If their data is priced too high, potential buyers can be dissuaded from purchasing the data. On the other hand, if their data is priced too low, entities may not realize the full value of their data. In some cases, an entity may wish to use their data as collateral, but the entity may not want their data to be available for purchase. In such cases, the systems and methods herein can enable an entity to securely store a copy of their data with a service or platform. The data can be held in escrow and accessed only in the event of default, foreclosure, or other events as described in a lending contract. For example, in some embodiments, an encrypted copy of the entity's data can be stored in a first data store, and an encryption key for accessing the encrypted copy of the entity's data can be stored in a second data store that is different from the first data store. In some embodiments, data from different entities can be stored in different data stores.

The systems and methods herein can provide a service to loan portfolio managers that allows them to include both the value of a borrower's data in their underwriting calculations and also the value of that data for use in collateralizing lending products. For example, while a borrower's data may technically be included as part of a senior security interest, very few (if any) lenders consider data during underwriting due to its inability to be included in GAAP compliant financials, its constantly changing form, the difficulty inherent in securing and selling data during a recovery process, and so forth. The systems and methods herein can mitigate these problems by acting as a data valuation service, storage service, escrow service, and potential monetization conduit, allowing the lender and the borrower to collaborate on more competitive terms. This can drive down borrowing costs, increase borrowing capacity, and/or improve recovery potential in the event of a loan default, which can be beneficial for both the lender and the borrower.

According to some embodiments herein, data can be valued based on significant drivers of value, such as age, longevity, freshness, number of attributes, types of attributes, region, industry, volume of data, uniqueness of records, completeness of records, data integrity, and so forth. For example, data may be worth more if it includes a large number of unique users with relatively complete data. On the other hand, data may be worth less if it is old or outdated, has incomplete records, contains significant errors or omissions, and so forth.

While data can be valuable, determining data valuations, improvements to datasets, and so forth can be infeasible. Datasets can be exceedingly large, for example comprising hundreds, thousands, millions, or more records and can include tens, hundreds, or thousands of attributes for those records. Moreover, the volume of data grows each day, and in some cases may grow at an increasing rate over time. Analyzing full datasets to determine the value of the datasets can require a technically and/or financial amount of computing resources, network resources, etc. For example, it could take several days to transfer very large datasets from a client to a data valuation, lending, or sales platform. Because datasets are often not static, it can be important to provide regular updates to the datasets, to update valuations of datasets, and so forth.

The systems and methods herein offer many technical improvements that can make it more feasible to evaluate datasets, improve datasets, sale datasets, use datasets as collateral, and so forth. For example, in some embodiments, valuations, recommendations, and so forth can be derived partially or entirely using metadata about datasets rather than the data itself. For example, valuations can be based on a list of attributes and other summary data about a dataset, such as number of records, completeness, uniqueness, growth rate, freshness, age, etc., as described herein. In some embodiments, metadata can be prepared on a client computing system and then send to a data platform for further analysis, processing, storage, etc. As a result, it may not be necessary to transmit a full dataset to the data platform in order to determine a value of the dataset, which can significantly reduce required network resources, significantly decrease the time required to determine a valuation, offer increased security (for example, data may be stored in fewer locations if it is not necessary to send the data to a data platform for valuation purposes, the data platform can store any received data in a secure manner as there may not be a need to access the actual data, etc.). As described herein, delta updates can be used to limit the amount of data that is transferred to the data platform as new records and/or attributes are added, deleted, or modified in a dataset.

### Data as Collateral

In some embodiments, a system can value and/or manage one or more datasets. In some embodiments, the one or more datasets can be used as collateral for a loan. In some embodiments, the one or more datasets can be used as partial collateral for the loan, for example in combination with other types of collateral (e.g., traditional forms of collateral such as accounts receivable, inventory, real estate holdings, and so forth). In some embodiments, the one or more datasets can include core data.

In some embodiments, the one or more datasets can be used to improve securitization of and/or modify an existing loan. The existing loan can include conventional collateral such as cash flow, inventory, accounts receivable, property, real estate, etc. In some embodiments, the one or more datasets can be used as additional collateral, thereby possibly increasing recovery upon default. In some embodiments, the one or more datasets can be used to renegotiate one or more terms of the existing loan, such as interest rate, repayment period, total loan amount, etc. The one or more terms can include using the one or more datasets as a collateral.

In some embodiments, the system can use the one or more datasets for evaluation of a new loan. The system can value the one or more datasets when the system evaluates one or more conditions of the loan and/or a value of an entity. In some embodiments, the system can evaluate the loan with and without the one or more datasets, and the system can evaluate a risk of the loan with and without the one or more datasets.

In some embodiments, the system can use only the one or more datasets as the collateral. In these embodiments, risk can be greater than in cases where the collateral includes other forms of collateral, because the loan is backed by only the one or more datasets, and the value of the datasets can change significantly over time, be subject to greater volatility than some other types of collateral, and so forth. As a result, terms may be less advantageous to a borrower, such as a higher interest rate, lower loan amount, faster repayment terms, and so forth. Data can present risks because, for example, a company may fail, and data can become stale while waiting for a foreclosure process to complete. In some cases, depending upon the particular data at issue, data can be akin to a perishable good, where the value of the data declines over time as it is no longer desirable to potential buyers.

In some embodiments, the system can use the one or more datasets to at least partially determine a valuation of an entity for investments, mergers & acquisitions, capital financing, initial public offerings, securities investing, or any other suitable purpose for which a data valuation may be desired.

In some embodiments, the system can use a multi-step valuation method to value the one or more datasets. In some embodiments, the system can automatically vet a plurality of applications for a plurality of entities. In some embodiments, the system can retrieve one or more surveys from the plurality of entities. The survey can include self-reported data related to a corresponding entity of the plurality of entities. In some embodiments, the self-reported data can include general information about the entity such as geographic information, business segment, revenue, profit, expenses, number of employees, number of clients, number of users, and/or any other entity-related information. In some embodiments, the self-reported data can include high-level information about the one or more datasets an entity such as data warehousing, a data size, a data type, and/or any other data information.

In some embodiments, the system can automatically determine if a loan application meets a predetermined threshold or criterion. The predetermined threshold or criterion can be based on one or more predefined rules. The predefined rules can include a minimum size of the one or more datasets, an accessibility of the one or more datasets, geographic limitations on monetization of datasets due to one or more known legal barriers (e.g., GDPR), limitations resulting from the type of data (e.g., health information, personal identifying information), and/or any other data characteristics. In some embodiments, there can be the same or different predetermined thresholds for entities who wish to sell their data rather than borrow against it. In some embodiments, thresholds, criteria, etc., can vary depending upon whether an entity wishes to sell its data on a one-off basis (e.g., a buyer purchases access to a current dataset, which completes the transaction) or on a continuing basis (e.g., a buyer purchases access to a current dataset and purchases updates to the dataset). In the latter case, criteria can include, for example, a minimum time in business, minimum revenue, etc. Such criteria can be used to reduce the likelihood that an entity goes out of business or is otherwise unable to fulfill its obligations.

In some embodiments, the system, if the application meets the predetermined threshold or criterion, can automatically transmit the application to a lender. In some environments, the application can include a portion of a dataset. The portion of the dataset can include a sample of typical data. In some embodiments, metadata can include summary information such as a size of the dataset (e.g., number of records), data storage information (e.g., total size of the data set, format in which the data is stored, etc.), number of unique users, number of unique primary keys (which can, in some cases, be a measure of the number of unique users, for example if each user is associated with a single primary key), age of the dataset, growth rate of the dataset, completeness of the dataset (e.g., a measure of how many attributes are missing for the records in the dataset), a freshness of the dataset (e.g., a measure of whether and how much recent data is included in the dataset) and so forth. In some embodiments, the metadata can include a list of attributes (e.g., fields) in the dataset.

In some embodiments, the system can use the portion of the dataset, the metadata, or both to determine a value of the dataset. In some embodiments, the system can automatically determine a volume, a depth, a uniqueness (e.g., a measure of how much repetitive or duplicate information is included in the dataset), a quality, a freshness, and/or a time period of the dataset. In some embodiments, the system can use one or more statistical models for the automatic determination.

In some embodiments, the system can use market research to automatically estimate the value of the dataset. In some embodiments, the system can use a cost-based estimation. The system can use the data storage information and the size of the dataset to automatically determine a cost of creating or a cost of obtaining the dataset. The cost of creating or the cost of obtaining the dataset can be an initial value of the dataset. In some embodiments, the system can automatically adjust the initial value to reflect contemporary environmental conditions. In some embodiments, the system can automatically subtract taxes (e.g., estimated taxes) from the initial value to reflect an impact of deducting a cost to create the dataset from an income of an entity. The system can automatically determine a value of the dataset based on the automatic adjustment of the initial value and the subtraction of taxes.

In some embodiments, the system can use relief from royalty to automatically estimate the value of the dataset. The system can determine an avoided cost to license the dataset from a third party to estimate the value of the dataset. In some embodiments, the avoided cost to license can be adjusted on a compounded basis at a rate equal to an estimated cost of capital to finance the avoided cost to license.

In some embodiments, the system can compare asking prices or determined values of other datasets to determine the value of the dataset. The system can retrieve the asking prices from over-the-counter contracts, traditional marketplaces, ransomware payoffs, and/or dark web marketplaces for data obtained in data breaches. In some embodiments, the system can compare market data of non-fungible tokens (NFT) assets to determine the value of the dataset. In some embodiments, market data related to data breaches, ransomware payments, NFT sales, etc., can be adjusted, given lower weight as compared to other sales channels, or both, because these sales may be weak indicators of the actual value of datasets on legitimate, established markets.

In some embodiments, the value of the dataset can be based on a degree of similarity of the dataset to other datasets and/or the value of the dataset can be based on a reliability of a market source. The system can automatically adjust the value of the dataset with a similarity multiplier, a depreciation rate multiplier, a liquidity multiplier, and/or a cash flow multiplier. The similarity multiplier can include what portion of marketable data exists in the dataset. The depreciation rate multiplier can include a decrease in usefulness of the dataset over time. The liquidity multiplier can include a present value of a payment for the dataset. The cash flow multiplier can include a present value or net present value of license or royalty payments for the dataset. In some embodiments, the net present value can be computed using one or more discount rates or other assumptions.

In some embodiments, the system can use artificial intelligence and/or machine learning to determine the value of the dataset. The system can periodically or continuously retrieve market study data using web tools, researchers, and/or crowdsourcing. The market study data can include a data schema and a price of a plurality of datasets. In some embodiments, the market data can include metadata of the plurality of datasets, such as a size of a dataset, an industry, a geographical region, etc.

In some embodiments, the system can use a regression model to predict a price per record. The system can use field (also referred to herein as attribute) data and the metadata to determine the price per record. The system can use each field (or a subset of fields) in a dataset as a separate data feature. The system can automatically map or convert each field (or subset of fields) of the dataset to a standardized model of feature fields. For example, in some embodiments, an artificial intelligence (AI) or machine learning (ML) model, such as a large language model (LLM), can be used to determine a type of data that a field contains. This can be significant because different datasets may store the same or similar information in fields with different names, different data formats, and so forth. In some embodiments, the system can automatically and dynamically update the standardized model of feature fields to include one or more new feature fields based on market study data, evaluated datasets, and so forth. The feature fields can be grouped into one or more groups. The one or more groups can include personal information, location information, financial information, health information, and/or domain information. The personal information can include demographic information (names, data of birth, gender, nationality, etc.), traditional identifiers (for example, social security numbers or other national identifiers, driving license numbers, passport numbers, other licenses, memberships such as in professional organizations, voting records, health records, insurance records, etc.), and/or modern identifiers (such as telephone numbers, emails, social network usernames, etc.). The location information can include current home address, current work address, historical home addresses, historical work addresses, travel records, and/or real-time location information. The financial information can include banking information (bank or credit card accounts; mortgages, auto and personal loans; and balances, transaction histories, etc.), credit information (credit scores, loan applications, delinquencies, collections, etc.), and/or payment information (purchases, payments, etc.). The health information can include clinical lab results and diagnoses, insurance claims, and/or prescriptions. The domain information can include attributes specific to a particular domain.

In some embodiments, attributes can be clustered, for example using K-means clustering or other clustering algorithms, such as centroid-based clustering, density-based clustering, grid-based clustering, etc. In some embodiments, attributes can be clustered based on roots of attribute names. For example, a common issue with identifying fields can be that different entities use different, but similar, names to represent the same attribute. For example, a user's last name can be stored in an attribute called lname, surname, lastname, name_last, name1, name2, name3, and so forth. In some embodiments, a system can be configured to extract a common or root name from fields. In the example of last names, each of the example attribute names contains the term “name.” Thus, for example, “name” can be the root for an attribute indicating a user's last name. It will be appreciated that while such clustering may not be perfect (e.g., in the example of last names, attributes that include a user's first name or middle name can also be included), such an approach can help to identify the type of information contained within an attribute, to determine similarity in attributes among different datasets, and so forth.

In some embodiments, after the system identifies each field in the dataset, the system can label each separate data feature as a presence of each particular field in the dataset.

In some embodiments, the system can use metadata as separate data features. The separate data features of the metadata can include business information (geographical region, type of industry, etc.), statistical information (such as data size, completeness, correctness, etc.), time domain information (time over which the data were created, velocity at which the dataset has increased, etc.), attributes (e.g., fields) of the dataset, and so forth.

In some embodiments, the system can use a trained artificial intelligence or machine learning (AI/ML) model to implement the regression model. The AI/ML model can be trained using a training dataset. In some embodiments, the AI/ML model can include supervised models such as Decision Forests, XGBoost, Support Vector Machines (SVM) and/or Stochastic Gradient Descent (SGD) regression models. In some embodiments, the AI/ML can include multi-layer perceptron (MLP) neural network regression models. In some embodiments, the AI/ML model can include a combination of a plurality of supervised models.

In some embodiments, the AI/ML model can use non-supervised models. The AI/ML model can use K-means and/or Hierarchical clustering to automatically identify clusters of fields that can add to the value of the dataset.

In some embodiments, the system can automatically generate a scorecard based on metrics determined from all or a subset of the plurality of datasets analyzed by the system. The scorecard can include a standard normal gaussian distribution. In some embodiments, a score of the scorecard can be directly proportional to a percentile. The score can include a plurality of factors such as geography, industry, and/or overall complexity (depth) of the dataset. In some embodiments, a score below a predetermined threshold can discount the value of the dataset. In some embodiments, the predetermined threshold can be the 10th percentile, 20th percentile, 30th percentile, 40th percentile, 50th percentile, 60th percentile, 70th percentile, 80 percentile, or 90th percentile, or any value between these values, or more or less. For example, in some embodiments the predetermined threshold can be the 80th percentile.

In some embodiments, the system can use clustering to determine common valuable and insignificant attributes of datasets. The system can divide data points into a number of groups such that data points in each of the number of groups is similar to other data points in a similar group. In some embodiments after the system divides the data points into the number of groups, the system can analyze each of the number of groups to determine if a discount should be applied, if a premium should be applied, if one or more additional attributes that could add value, and so forth, as described herein.

In some embodiments, the value of a dataset can be non-linear such that a value of the dataset is not directly a sum of each field. For example, a list of names alone or a list of email addresses alone may be of little value, but a list of names and corresponding email addresses may be of significant value. The value of the dataset can be based on a relationship between each field. In these embodiments, the system can automatically analyze the dataset to determine one or more additional fields to add to the dataset to enrich the dataset and increase the value of the dataset, the completeness of the dataset, and so forth. The system can automatically determine if value added to the value of the dataset is greater than the cost of enriching the dataset (retrieving the one or more additional fields, effort of processing the enrichment, etc.). In some embodiments, the system can automatically determine if the value of the enriched dataset minus the cost of enriching the dataset is greater than the value of the dataset.

### Vaults

In some embodiments, a platform that provides valuation services, lending services, data transaction services, and/or the like can maintain a copy of data (e.g., to be accessed in case of default, for transfer to another party upon sale, and so forth). Securing the data can be important as there are significant risks if data is subject to unauthorized access. For example, the value of the data could be negatively impacted if the data is leaked, the reputation of a company that owns or controls the data could be negatively impacted, and so forth. Accordingly, it can be important for the platform to store data in ways that reduce the likelihood of unauthorized access to data and/or that, in the event of unauthorized access, limit the potential impact of an unauthorized access event. In some embodiments, access to data, account settings, and so forth can be secured using passwords, passkeys, two-factor authentication, physical authentication tokens, or the like.

In some embodiments, the system can use vaults to encrypt archives of data. The vaults can include content from entity databases. The system can encrypt the data using an asymmetric key pair. The entity can use an application (also referred to herein as an agent) to access a public key and a symmetric data key. The system can store private keys using a key management service (KMS), hardware security module, and/or the like.

The system can store vaults in one or more data storage volumes, for example one or more cloud data storage volumes. In some embodiments, the system can store vaults in AMAZON S3 buckets or other data storage volumes. In some embodiments, data storage volumes can be unique to each entity (e.g., a vault can contain data for a single entity). In some embodiments, the system can store vaults in an immediately (or near immediately) accessible manner, for example in an online cloud storage platform. In some embodiments, the system can store vaults using a less accessible means, for example in offline backups or archives, in low speed archival systems, in tape backups, optical disc backups, etc.

In some embodiments, an entity can export data of the entity via the application to the system, and the system can analyze the data to determine metrics of the data. The system can use the metrics as a baseline for a dataset. The system can encrypt the exported or extracted data and transmit the exported or extracted data to a created vault associated with the entity. In some embodiments, the system can periodically receive and store one or more snapshots of exported or extracted data as the dataset is updated or changes incrementally. In some embodiments, the system can receive one or more snapshots daily (e.g., an agent or application running on an entity's computing resources can transmit one or more snapshots on a regular basis, such as daily, and can upload them to the system). In some embodiments, the snapshots can include create, read, update, and delete (CRUD) operations. The system can transfer a delta update of the incremental updates as a flat file to a vault. In some embodiments, the delta update can include an indication of a disruption of the application, volumetric changes, schema changes, new table creation, new data stores, and/or client infrastructure migrations or technology changes. The application can analyze one or more snapshots to track metrics. The application can encrypt the one or more snapshots and transmit updates to a server or the vaults. In some embodiments, the system can automatically recover or transmit alerts based on the delta update.

In some embodiments, an entity can install an application or agent on a system of the entity, and the system can analyze one or more datasets and provide a summary to a platform. In some embodiments, the platform may not receive a readable copy of the data or may only receive a readable sample of the data. Using such an approach, a potential client can obtain a valuation of their data without having to share their data with a platform (or with only sharing a subset of data with a platform). Such an approach can give potential clients confidence that their data remains secure while they are considering whether or not to monetize their data.

In some embodiments, the metrics can include the total number of records, record size, updated records, deleted records, a number of columns, new columns, deleted columns, an archive file size, an MD5 hash or other hash, date and/or time of the snapshot, optional query results, optional log output, any combination of these, or any other metric or combination of metrics.

In some embodiments, the system can maintain and back up the vault throughout a period of a loan. In some embodiments, after the period of the loan, the system can automatically delete or destroy all copies of the data and associated encryption keys. In some embodiments, the system can log the deletion for audit and transmit a notification to an operations team and the entity.

In some embodiments, the vault can be stored in a storage system such as AMAZON S3, AMAZON GLACIER, or another storage medium or storage service as zip file archives or other compressed archives that cannot be queried. In some embodiments, the system can store the metrics as database records in a relational database, for example using AMAZON RDS, for performance monitoring, derivative insight development, and so forth. In some embodiments, the system can check for data integrity before and after transmission using MD5 or other hashes to determine if the data is corrupted. Data corruption can indicate a system level issue, tampering, and/or disruption between the system and the entity.

### Foreclosures

In some embodiments, if an entity defaults on a loan, the system can automatically decrypt the data or the system can decrypt the data after a review process. In some embodiments, the review process can include one or more signatures from review staff. In some embodiments, data may be decrypted only at the conclusion of legally prescribed foreclosure proceedings. In some embodiments, if an entity defaults, the system can automatically transmit a notification to the review staff. The notification can instruct the review staff to review the default and/or approve the foreclosure by signing an authorization in a customer relationship management (CRM) system or other system. In response to the approval and signature, the system can automatically trigger an unlock process. For example, the system may communicate with the CRM system via an API such that the system can receive a notification from the CRM system to trigger the unlock process (e.g., the CRM system can push a notification to the system, or the system can query the CRM system). The system can copy snapshot files into a staging area or other storage medium such as a foreclosure database. The system can track foreclosed datasets with a uniform resource identifier (URI), and the system can associate the foreclosed dataset to, for example, a borrower identifier (BorrowerID), lender identifier (LenderID), and/or vault identifier (VaultID) such that the system can track monetization recovery results.

In some embodiments, the system can store the foreclosed datasets using a storage service, for example AMAZON S3 or AMAZON GLACIER, as flat files for long term archiving. In some embodiments, foreclosed data can be stored in a relational or NoSQL database. After the system extracts the data and completes the foreclosure, the system or the review staff can review the foreclosed datasets for content and monetization readiness in a read only format such that the foreclosed datasets cannot be modified, enriched, or directly downloaded by buyers.

In some embodiments, after the foreclosed datasets are imported into the archive, the system can create a product dataset. The product dataset can be a copy of the foreclosed datasets, a combination of a plurality of foreclosed datasets, or a subset of data in one or more foreclosed datasets. In some embodiments, the system can create custom datasets based on user requests.

In some embodiments, the system can track the product datasets using a URI and associated product identifier (ProductID) and status (e.g., for sale, internal use, archived). In some embodiments, the system can promote the product dataset with text descriptions, set pricing details, create custom licensing terms, etc. As described herein, in some embodiments, text descriptions can be automatically generated, for example using an LLM. For example, an LLM may be provided with a list of attributes for the dataset, information about the source of the data, and/or the like, and the LLM can be prompted to generate a description of the data, a description of the attributes, and/or the like.

In some embodiments, the system can offer the product datasets on various sales channels. The system can track leads and sales performances. In some embodiments, the product datasets can be associated with foreclosure identifiers (ForeclosureIDs) of the datasets included in each product dataset and/or the ProductID in a backend database. In some embodiments, after a product dataset is sold, all or a portion of an overall revenue can be associated with the foreclosed account and associated loan identifier (LoanID) for recovery purposes.

In some embodiments, analysts can have read/write access to product datasets.

### Accelerated Payback

In some embodiments, a new loan is placed using standard origination or servicing processes. After a period of service (e.g., 30 days) and payment of fees, a borrower can join a lending system. The borrower can transfer a dataset to a vault. The system can automatically standardize, value, and/or clean the dataset. The system can market the dataset and sell the dataset a plurality of times. Proceeds from sales of the dataset can be placed in escrow for repayment of the loan upon default. In some embodiments, proceeds can be automatically applied for repayment upon the occurrence of a condition that triggers accelerated payback, such as delinquency, default, a period of the borrower not uploading data, evidence of the borrower tampering with data (e.g., deleting records, modifying records to conceal information that should not be concealed), and so forth. In some embodiments, money received from the sale of data can be used to offset required payments on a loan (e.g., if a loan payment is $1,000 and data sales for a month are $450, the entity may only need to pay the remaining $550).

### Example Embodiments

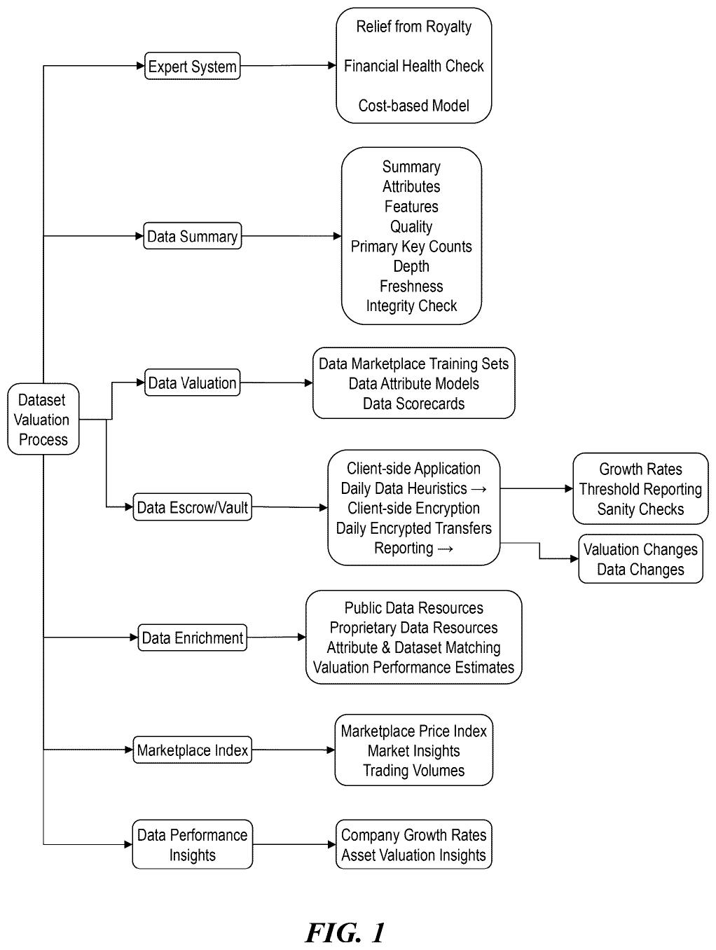

FIG. 1 provides an overview of data valuation processes and associated offerings according to some embodiments. In some embodiments, an expert system can be used for relief from royalty value estimations, financial health checks, and/or cost-based modeling. In some embodiments, the system can include data summary functionality. The data summary functionality can provide a summary of data such as attributes (e.g., fields in a database table), features, quality, primary key counts (which can indicate, for example, a number of unique individuals or users in a dataset), depth, freshness, integrity, and so forth. In some embodiments, the system can perform data valuation. Data valuation can utilize, for example, data marketplace training sets, data attribute models, and/or data scorecards. In some embodiments, the system can provide an escrow/vaulting system. In some embodiments, the vaulting system can include a client-side application (also referred to herein as an agent). In some embodiments, the system can collect, using the agent, daily data heuristics. In some embodiments, daily data heuristics can include sanity checks, threshold reporting, growth rates, or any other metadata. In some embodiments, an agent can use client-side encryption. In some embodiments, the agent can enable encrypted transfers to a backend server. In some embodiments, the encrypted transfers can occur on a regular basis, for example daily, weekly, monthly, quarterly, etc. In some embodiments, the systems and methods herein can use delta updates, such that only changes to a dataset (e.g., new records, modified records, deleted records) are uploaded, which can reduce the volume of data to be transferred. In some embodiments, the system can include reporting features. Reporting can include information about, for example, valuation changes, data changes (e.g., changes in attributes that are collected), etc.

In some embodiments, the data valuation system can enable associated offerings. For example, associated offerings can include data enrichment, marketplace indices, data performance insights, etc. Data enrichment can make use of, for example, public data resources and/or proprietary data resources. As just one example, if a dataset contains an attribute for zip code, the data can be enriched to include city and state.

In some embodiments, the system can provide attribute and dataset matching. For example, in some embodiments, a system can receive a natural language request from a data purchaser or data broker and can, using an LLM or other AI/ML model, determine datasets that contain the attributes requested by the borrower or broker. In some embodiments, the attributes in a dataset can be provided to an LLM, and the LLM can output descriptions of the attributes which can be queried or searched. In some cases, the descriptions generated by the LLM can enable relatively easy searching, for example when attributes have names that commonly appear in other datasets. In some embodiments, the system can provide valuation performance estimates.

In some embodiments, a marketplace index can provide a pricing index, market insights, trading volumes, etc. In some embodiments, data performance insights can include, for example, company growth insights, asset valuation insights, and so forth.

Various aspects of the data valuation process and associated offerings will be described in more detail herein.

In some embodiments, the systems and methods herein can be used to determine a value for data owned by an entity. In some embodiments, the determined value can be used for lending purposes, used as a basis for pricing the data on an open market or in a private sale, and so forth. In some embodiments, if data is sold, there may be an exclusive agreement with a single buyer. In some embodiments, data may be sold to multiple buyers. The value of a dataset can depend on where it is sold (e.g., the type of market), to whom it is sold (e.g., to a data broker or directly to a data consumer), and the terms of the sale (e.g., limited access, permanent access, exclusive, non-exclusive, etc.).

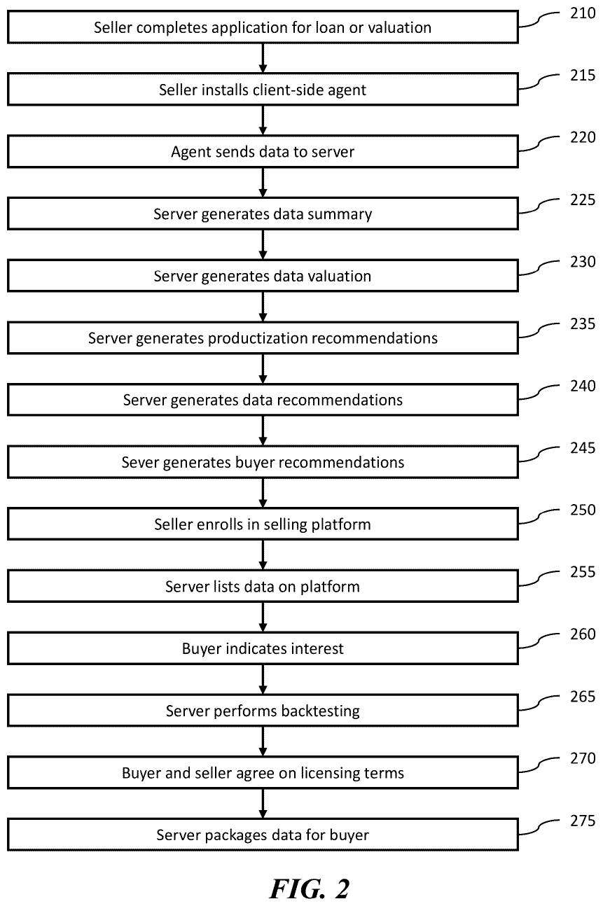

FIG. 2 illustrates an example process for selling data on a platform according to some embodiments. The process depicted in FIG. 2 can be performed on one or more computer systems.

At step 210, a client (e.g., a borrower or seller) can complete an application for a loan or valuation. For example, the client may fill out a form that indicates information about the client, the client's line of business, the client's finances, etc. At step 215, the client can install a client-side agent that can collect information about the client's data. In some embodiments, the agent can process and analyze data on the client's computing hardware (or, for example, on data stored in a cloud service associated with the client). In some embodiments, the client may only share summaries, analyses, etc., with the platform, and may not share raw data with the platform. In some embodiments, the client may share a sample of the data with the platform. At step 220, the agent can send data to the platform. For example, the agent can send summaries, analyses, a list of attributes, etc. The data can include, for example, information about the uniqueness of records in a dataset, duplicates in a dataset, completeness of a dataset, age of a dataset, freshness of a dataset, etc. At step 225, the platform can generate a data summary. The data summary can include, for example, total number of records, number of unique keys, number of attributes, names of attributes, data age, etc. In some embodiments, the agent may be used to determine the data summary, and the platform may not generate a data summary, or may generate a data summary that includes other summary parameters. In some embodiments, the platform can generate a list of attributes of the database. At step 230, the platform can generate a data valuation based on the data summary and any other received information, such as a list of attributes in the dataset. At step 235, the platform can generate productization recommendations as described herein. At step 240, the platform can generate data recommendations as described herein. At step 245, the platform can generate buyer recommendations as described herein. For example, the platform can identify buyers who may have an interest in buying the seller's data. Buyers can be based on, for example, industry (e.g., buyer and seller are in a common industry), attributes (e.g., buyer has previously bought data with attributes similar to those in the seller's data), and so forth.

If a client chooses to continue with the process of selling their data, the client can proceed to step 250 and enroll in a sales platform or a sales portion of the platform. In some embodiments, the sales platform can be the same platform as the platform that generates the data valuation. In some embodiments, a third party platform can be responsible for selling data. At step 255, the platform can list the client's data on the platform. At step 260, a buyer can indicate interest in the client's data. At step 265, the platform can perform backtesting, for example to ensure that the client's data is in condition for sale. At step 270, the buyer and client can agree on licensing terms. For example, the client may sell the data to a buyer for a one-time fee, may provide access to the data for a fixed period of time, may have an exclusivity agreement with the buyer, may charge a monthly or annual fee for access, may provide access only to existing data, may provide access to existing data and new data, etc. At step 275, the platform can package the data and make it available for the buyer to access. In some embodiments, the client can choose whether or not to accept an offer from a buyer (for example, a buyer can submit a bid price for the client's data). In some embodiments, the client can set a price, or the platform can set a price, and a buyer who offers the requested price can purchase access to the client's data.

In some embodiments, a platform can provide explanations for the value of a client's data. For example, the platform may inform the client that the data is too small, too new (e.g., has only limited history), too old (e.g., contains old data but does not contain enough recent data), too incomplete, has too many duplicates, lacks enough unique users, and so forth.

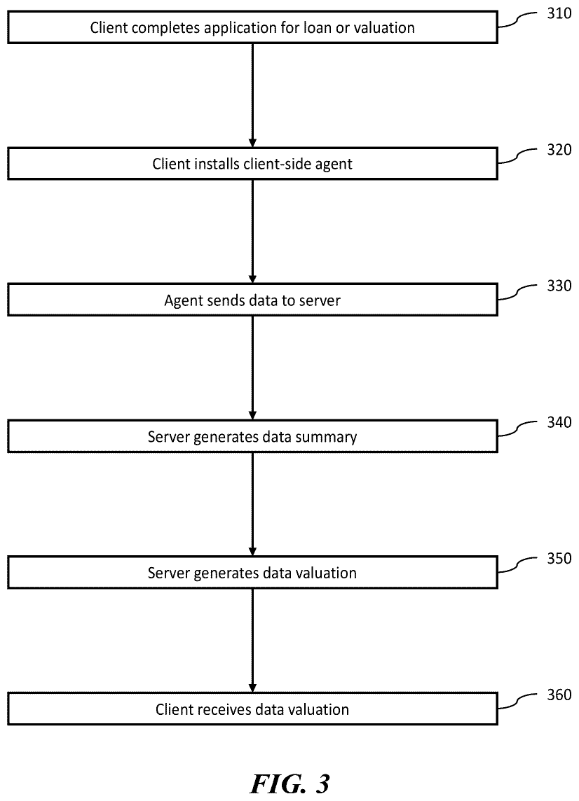

FIG. 3 illustrates an example data valuation process according to some embodiments. The example process of FIG. 3 can be carried out on computer systems. At step 310, a client can complete an application for a loan or valuation. At step 320, the client can install a client-side agent, which can parse and analyze the client's data without transmitting the client's data to a server or other device outside the client's control. At step 330, the agent can send (e.g., over a wired or wireless network) data to a backend server operated by a data valuation platform for further processing and valuation. At step 340, the server can generate a data summary of the client's data. At step 350, the server can generate a valuation of the client's data. At step 360, the server can provide the valuation to the client. For example, the valuation may be provided in the form of an email, PDF, web page, etc., that is accessible by the client.

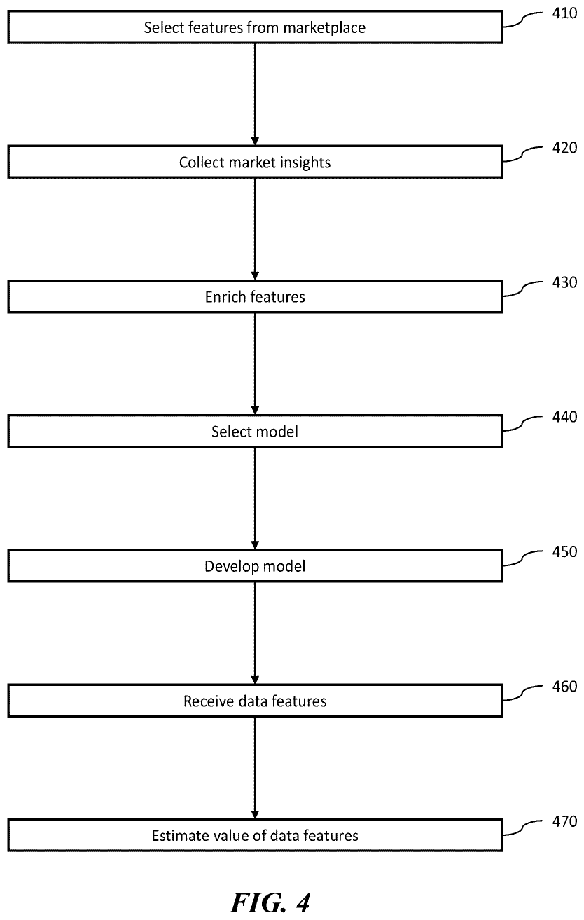

FIG. 4 illustrates an example process for estimating a value for a dataset according to some embodiments. The process illustrated in FIG. 4 can be performed on a computer system. At step 410, the system can access a marketplace data store and select features. For example, the system can access information such as sales volumes, particular attributes included in sold datasets, sales prices, and so forth. The marketplace data store can be a repository (e.g., a database) that includes data transaction information from public sources, private sources, etc. In some embodiments, the marketplace data store can include data from data brokers. In some embodiments, the marketplace data store can include ransomware payments, darknet sales, and so forth. In some embodiments, the selected features can include, for example, data subject, industry, mapped industry, geography, number of records, number of unique users, number of records per unique user, number of attributes, names of attributes, etc. In some embodiments, users may instead be products, companies, shipments, etc. In some embodiments, the marketplace data store can include pricing data for each dataset that has been sold.

In some embodiments, the valuation process can, in some respects, be similar to market comparables in other industries such as real estate. However, there are important differences when determining the value of data. For example, a client's dataset may have tens, hundreds, or even thousands of attributes. However, data sold in open and private markets typically has a more limited number of attributes. For example, a buyer may purchase a dataset that includes names, addresses, and phone numbers but that does not include other data a client may have, such as access times, device identifiers, birthdays, etc. In some embodiments, a machine learning model can be used to develop insights into the value of a client's data based on sales of data that contain certain attributes that may be present in the client's data.

At step 420, the system can collect market insights. For example, different features may be more or less important for different industries, different geographies, etc. At step 430, the system can perform data enrichment. In some embodiments, features that are of higher importance can be weighed more heavily, while features of lesser importance to the market may be weighed less heavily. In some embodiments, enrichment can be positive or negative. For example, there can be indicators of low data quality, such as high rates of duplication, high level of similarity between records, fewer a threshold number of unique users (e.g., fewer than 500,000 users), fewer than a threshold number of records per user (e.g., fewer than 5 records per user). Positive indicators can be determined from market insights, e.g., based on market demand. In some embodiments, enrichment can include filling in missing data or otherwise modify the data to make it conform more closely to expected model inputs. For example, interpolation or other techniques can be used to make discrete data continuous. In some embodiments, data enhancements can include translating information for other purposes. For example, enrichment can include taking data from one geographic area and applying transformations so that the data is appropriate for another geographic area. As described herein, a client's dataset can be very different from a dataset that is sold through open markets, private sales, etc. Thus, there can be numerous enrichments made to the client's data so that is most closely reflects data that is available on markets. In some cases, feature enrichment can include, for example, normalizing pricing. For example, prices may be in different currencies, may cover different periods of time, etc. Thus, for example, pricing information may be converted so that is in a common currency, prices may be transformed to represent the price over a particular time period (e.g., cost per year), price per data unit, or some other uniform pricing approach. In some embodiments, feature enrichment can result in the production of new features. For example, in some embodiments, two or more features may be strong indicators of value and may be combined into a composite feature.

At step 440, the system can select a model for training. For example, in some embodiments, there may be multiple models for estimating the value of a dataset. For example, models may be trained using different training data, may be trained using different features as inputs, etc. At step 450, the system can develop the model. For example, the system can perform machine learning model training (for example as described herein) to train the model to estimate the value of a dataset based on various features. In some embodiments, developing the model can include model validation. For example, in some embodiments, the output of the model can be compared to known sales prices of datasets to determine how closely a predicted sales price matches an actual sales price.

After a model is trained, the model can be deployed for use in evaluating client data to determining an estimated value of a client's dataset. At step 460, the system can receive data features for a client's dataset. At step 470, the system can use the trained model to estimate the value of the client's dataset. In some embodiments, the system may generate an output of the estimated value of the client's dataset. The output can be included in a report, which may comprise an email, a PDF, a spreadsheet, a web page, etc.

In some embodiments, predictive features of a dataset can be isolated from cleaned and normalized market research data (e.g., to remove outliers, to normalize units, to conform to formats (e.g., address formats, date formats, temperature scales, etc.) before being fed into a machine learning model.

In some embodiments, only one model may be used when evaluating the value of a client's dataset. However, as mentioned above, in some embodiments, there can be multiple models. In some embodiments, the client dataset features can be provided to a plurality of models to generate a plurality of estimates. The plurality of estimates can be used to provide an expected range of values at which the client's dataset would sell. In some embodiments, a model may output an estimated value on the open market, in a private broker sale, in a direct sale to an interested party, in a sale to a data aggregator, etc. In some cases, the value of a dataset can depend significantly on the sales channel for the dataset. For example, a dataset may sell for a higher amount when sold directly to another party that is interested in using the data than, for example, when the data is sold to a data broker who will subsequently attempt to resell the dataset.

In some embodiments, a valuation process can include a plurality of machine learning models. In some embodiments, a valuation process can include a qualitative model, a quantitative model, or both. In some embodiments, a quantitative model can be used to predict values from selected categorical and/or numerical features of a database. In some embodiments, a model can be trained to map one or more selected features to pricing outputs. In some embodiments, a model can be trained to minimize prediction errors using one or more optimization techniques such as gradient descent, cross-validation of model parameters, etc. In some embodiments, a qualitative model can be used to make value predictions based on description features of a database or dataset. For example, in some embodiments, a qualitative model can be trained to identify important and relevant natural language features of a dataset. In some embodiments, a qualitative model can use recursive forward and backward selection across an ensemble of neural networks and/or other models/algorithms.

In some embodiments, one or more models can be combined or hybridized to determine a market value of a dataset. For example, the outputs of a plurality of models can be combined to determine a value of a dataset. For example, in some embodiments, a system can be configured to apply a first valuation model to a first subset of marketplace metadata (e.g., metadata of datasets sold on one or more marketplaces) to determine a first sales price metric (which can be the sales price or a metric that can be used to determine the sales price) and can apply a second valuation model to a second subset of marketplace metadata to determine a second price metric. In some embodiments, the system can be configured to use the first price metric and the second price metric to determine a value of a dataset. For example, a first valuation model can be trained using quantitative data and a second valuation can be trained using qualitative data. It will be appreciated that this is just one example, and other approaches are possible.

In some embodiments, a machine learning model can be improved over time. For example, in some embodiments, historical client data valuations can be evaluated and used to explore and learn new information relevant to dataset valuation. In some embodiments, public market data, private market data, internal platform data, and so forth can be used to improve a valuation model.

In some embodiments, multiple valuations can be calculated using multiple models. In some embodiments, an output can be provided to an entity that shows which models were used, an estimated reliability of the model (which can be determined based on, for example, estimated value and actual value of sold datasets), training set scores, etc. In some embodiments, the output can include an overall ranking of the model output, the number of datasets in a training set, and so forth, which can help entities to evaluate the reliability of the outputs of each model.

### Data Valuation Scoring

In some cases, it can be desirable to evaluate datasets relative to other datasets that have been valued according to the processes described herein. For example, a client may wish to know if their data is among the best data that has been valued, typical for data that has been valued, or below average as compared with other data that has been valued. For example, a client whose data scores relatively low may wish to take action to improve the quality of their data, for example by eliminating duplicates, improving the collection of attributes, etc. For example, a client may change some attributes from optional to required when a user submits a form. In some embodiments, a client may backfill attributes, for example by consulting another data source or deriving the attributes from information the client already has (for example, a client that has city and state information could readily determine county, time zone, etc.).

In some embodiments, data scores can be based on, for example and without limitation, any combination of country gross domestic product, geography, an upper limit on the valuation, a lower limit on the valuation, number of records, number of attributes, number of geographies, age, number of market ready attributes, ratio of market ready attributes to total attributes, average record similarity, primary key for records, average percentage of records containing all attributes, number of unique records, number of unique users, and so forth. In some embodiments, data scores can, additionally or alternatively, be based on rates of duplication, historical data valuations, market insights, and/or qualitative measures, such as whether or not the data contains personal identifying information, whether the data contains more than a threshold number of records (e.g., greater than one million records, and so forth. In some embodiments, the data score can, additionally or alternatively, be based on any combination of total unique users, average number of records per user, rate of record duplication, data growth rate (e.g., year-over-year growth), primary key for users (e.g., social security number, email address, first and last name, etc.), record similarity, and so forth.

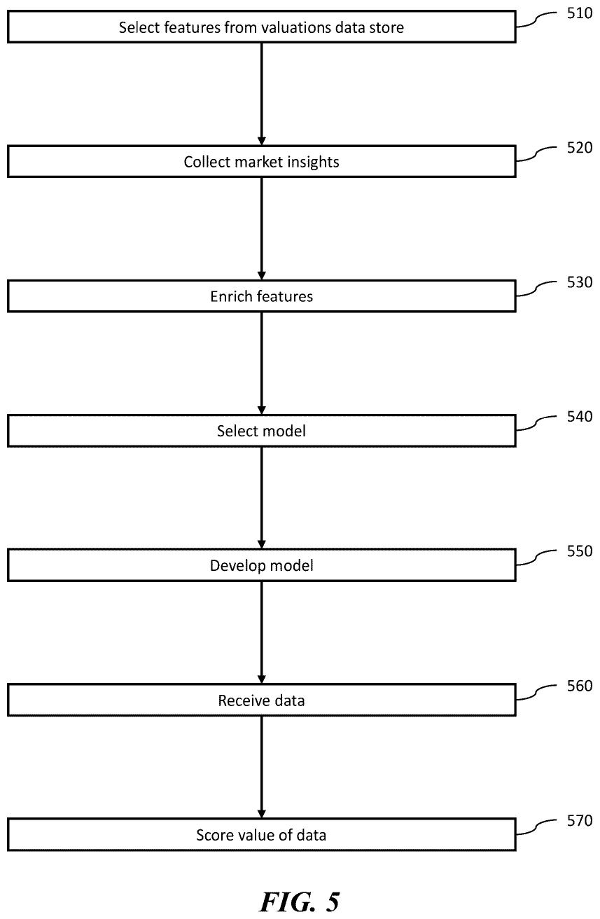

FIG. 5 is a flowchart that illustrates an example data value process according to some embodiments. The process depicted in FIG. 5 can be performed on a computing system.

At step 510, the system can select features from a valuations date store. The valuations can be a store (e.g., a database) of previously valued datasets. In contrast to the marketplace data store, which can include actual sale prices of datasets, the valuations data store can store the valuations of other datasets as determined using the systems and methods described herein. At step 520, the system can collect market insights. At step 530, the system can enrich features as described herein. At step 540, the system can select a model as described herein. As discussed above with respect to determining valuations for datasets, there can be multiple models for scoring the valuation of a dataset relative to previous valuations of other datasets. At step 550, the system can develop the selected model, for example using a machine learning model training process.

At step 560, the system can receive data for scoring a dataset valuation. For example, the system can resume a summary of the data, valuations of the data, and so forth. At step 570, the system can score the valuation of the data.

In some embodiments, scores can be normally distributed. For example, scores within one standard deviation of the mean score can be considered average performers, scores more than one standard deviation below the mean can be considered low performers, and scores more than one standard deviation above the mean can be considered high performers. The scores can be representative of metrics derived from datasets valued by a data valuation platform. The score can consider external factors, the overall complexity of a dataset, the overall depth of a dataset, and so forth.

Clients can use the score to determine whether improvements to the dataset may be worthwhile. For example, a client whose dataset scores in the low performer group may see significant value increases by improving the dataset.

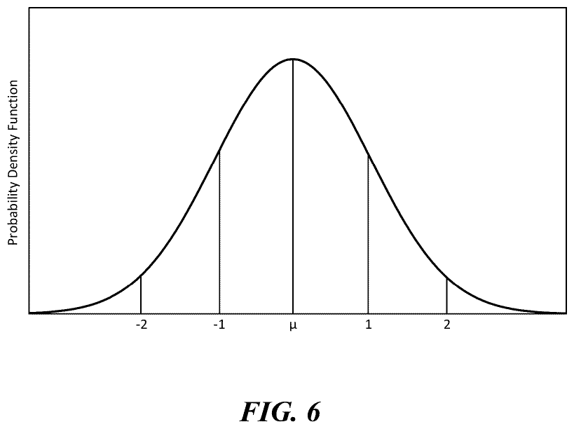

FIG. 6 shows an example of a normal distribution of value scores according to some embodiments.

Valuation reports can be of great importance to clients who wish to use their data to borrow, sell, and so forth. Consultants and other individuals can make use of valuation reports when evaluating the value of a client's data, to recommend improvements to a client's data, and so forth.

While a value score as described herein can provide valuable insight, it can be significant to respond to borrower, seller, and/or buyer demand using key performance indicators to judge the quality of a dataset. The value score as described herein can provide some insight, but it can be difficult to ascertain actionable information from a value score alone.

When a client sees a valuation report, often they would like to be able to easily determine how their dataset compares to other datasets. The value score provides an overall picture of how their dataset compares to other datasets but may not provide details that can explain why their dataset fared better or worse than other datasets. Clients may want to see how their dataset compares to other datasets in an industry, to a best-in-class dataset in an industry, to their own previously evaluated datasets (e.g., to see if the values of their datasets are increasing, decreasing, or remaining stable over time), and so forth.

In some cases, data quality, risk, and so forth can be judged based on past experience, gut feelings, and so forth. However, such approaches can be unreliable and inconsistent. For example, different individuals may bring their own past experiences, biases, skepticism, enthusiasm, etc., into play when evaluating a dataset. Such an approach may not accurately reflect how a data set compares to other datasets that have previously been evaluated, to market research data, and so forth. Thus, there is a need for systems and methods that can be used to provide consistent, accurate insights into datasets.

In some embodiments, a value score can be determined using a specific set of features from datasets. In some embodiments a value score can be a single value in a bounded range (e.g., 0 to 1, 0 to 100, 1 to 10, etc.). In some embodiments, the value score can be a score that measures the overall quality of a dataset relative to other datasets that have previously been evaluated. In some embodiments, a value score can evolve over time. For example, the value score can change because of changes in the dataset itself, changes in the other datasets that have been evaluated, the passage of time (e.g., a dataset may become stale over time), and so forth. For example, if a first dataset does not substantially change but other clients with similar datasets make significant improvements, a value score for the first dataset can decrease because, although the first dataset has not substantially changed, it is now worse relative to other datasets. In some embodiments, historical value scores can be stored. In some embodiments, historical values scores may not be stored.

In some embodiments, a value score can be based on one or more of record count, user count, rate of duplication, attribute count, geography, record similarity, year over year growth rate, market-quality attribute count, and so forth.

While an overall value score can be useful, as described herein, it may provide limited insight because, for example, clients may not readily understand the drivers of a particular value score and determining the drivers may involve significant effort or investigation.

In some embodiments, a plurality of inputs can be used to create qualitative, bound metrics that can be used to make faster decisions, to more easily gain insight into the reasons for a valuation, to evaluate datasets on a more standardized and reproducible basis, and so forth.

In some embodiments, subscores can be based on one or more metrics. In some embodiments, subscores can be bound to one or more ranges. In some embodiments, subscores can include relative measures of metrics, for example relative to other evaluated datasets, relative to information determined from market research (e.g., demand for particular attributes, demand for data in particular industries, etc.), and so forth.

In some embodiments, a scoring system can reflect results at the time they were initially determined. In some embodiments, a scoring system can dynamically adjust scores based on, for example, current conditions. For example, as time passes, more datasets can be evaluated, and a score may improve or decline as additional datasets are evaluated. For example, in some embodiments, a subscore can be a measure of how a raw subscore for a data set compares to raw subscores for other datasets, and the subscore can change as additional raw subscores are generated. In some embodiments, historical subscores can be stored. In some embodiments, a system may only make a current subscore available.

In some embodiments, a subscore may be assigned to a numerical range. In some embodiments, a numerical range can be continuous. In some embodiments, a numerical range can be restricted, for example restricted to only the integers 0 through 5. In some embodiments, letter grades can be used, and a dataset subscore can be scored as, for example, A, B, C, D, or F, with A indicated a high subscore and F representing a low subscore. Such representations can make it easier for analysts, consultants, clients, and so forth to better understand scores when compared to peers, industries, and so forth.

Various qualitative and/or quantitative measures can be considered. For example, measures can include data quality, market readiness, data depth, historical range, geographic coverage, scarcity, buyer demand, compliance risk, and so forth.

In some embodiments, data quality can include a calculation of a rate of duplication and record similarity as compared to other datasets in a cohort. For example, a data quality metric can be negatively impacted by a high rate of duplication, a high rate of record similarity, a high rate of incomplete attributes, and so forth.

In some embodiments, a market readiness metric can include a range of attributes that are market quality as compared with other datasets in a cohort. In some embodiments, a market readiness metric can leverage a product recommendation model. In some embodiments, datasets with relatively high market quality and a relatively low number of attributes (e.g., less than about 50 attributes) can score higher than datasets with relatively low market quality and relatively high numbers of attributes may score lower. For example, if there are few market quality attributes, a relatively large number of attributes, or both, there may be a need to carry out significant transformations, filtering, and so forth before taking a dataset to market, which may incur significant effort and expense.

In some embodiments, a data depth metric can account for a size of a dataset relative to other datasets in a cohort. For example, larger datasets with greater numbers of attributes can generally (though not necessarily) score higher than smaller datasets with fewer numbers of attributes.

In some embodiments, a historical range metric can be used to account for the historical range of a dataset as compared with a cohort. For example, data buyers can typically prefer datasets that have a history of at least two years, so data sets with a longer history can typically score higher. In some embodiments, the historical range metric can consider growth rates (e.g., year over year, month over month, etc.). For example, a dataset with a high growth rate can generally score higher than a dataset with a low or negative growth rate.

In some embodiments, a geographic coverage metric can be a weighted score of geographic coverage for subjects in a dataset as compared with a cohort or can be based on geographic coverage of a number of global segments (e.g., North America, Latin America, Europe, East Asia, Africa, etc., or subdivisions such as U.S. mid-Atlantic, south, midwest, southwest, west coast, New York, California, Texas, Florida, etc.). In some embodiments, the value of a dataset can depend significantly on the geographic areas represented in the dataset.

In some embodiments, a scarcity metric can be based on the scarcity of data attributes in a dataset as compared against a market or against other datasets in a cohort. For example, attributes such as first name, last name, and email are common and have low scarcity, while attributes that appear rarely in datasets can result in a high scarcity metric value if the scarce attributes are attributes that are of interest to buyers.

In some embodiments, a compliance risk metric can measure the compliance risk of a dataset. For example, datasets with personally identifiable information (PII), protected health information (PHI), and so forth can have a relatively high compliance risk and could have a low compliance risk metric. In some embodiments, a compliance risk metric may be lowered because, for example, the dataset contains information related to GDPR subjects. Significant work can be involved in cleaning such risky datasets for use.

The metrics described above can provide valuable insight into how a dataset compares to other datasets, but interpreting the data may nonetheless prove difficult. Accordingly, it can be beneficial to provide a visual representation that enables a client to easily interpret such metrics. In some embodiments, a radar chart (also referred to as a spider chart or web chart) can be used. A radar chart can be a graphical representation used to display multivariate data in a two-dimensional format. A radar chart can be particularly useful for comparing the performance or characteristics of multiple entities across various variables, for example comparing datasets across the metrics described herein.

In a radar chart, each variable can be represented by a spoke extending from a central point. The length of each spoke can correspond to the value of the variable. Each spoke can be connected to create a polygonal shape, which can be used to help visualize the overall pattern of values and allow quick comparisons (e.g., comparisons between datasets). According to some embodiments herein, spokes can be connected by straight lines. In some embodiments, spokes can be connected by arcs.

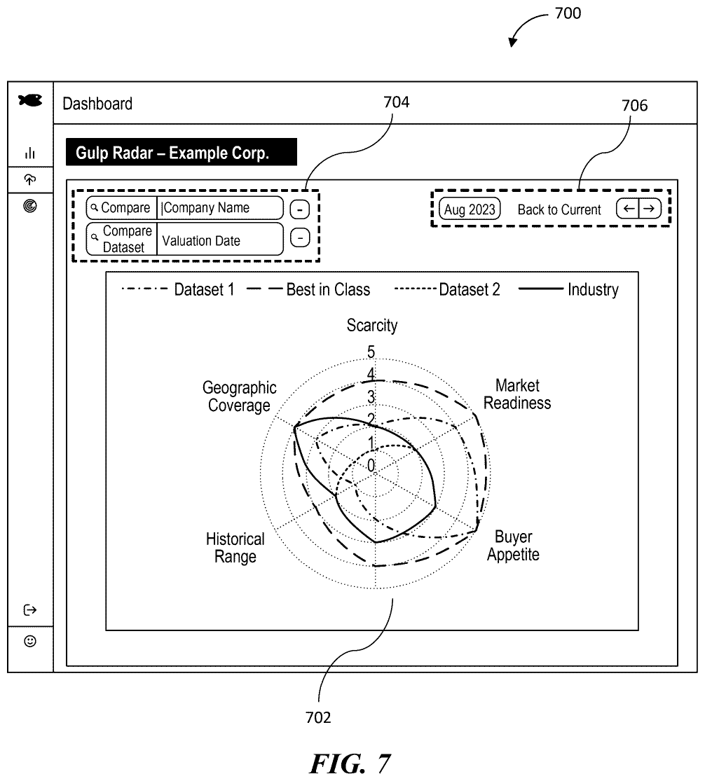

FIG. 7 illustrates an example user interface according to some embodiments. As shown in FIG. 7, a user interface 700 can include a radar chart area 702. The radar chart area 702 can be configured to show a radar chart that can be used to show a radar chart for a single dataset or for multiple datasets. For example, in FIG. 7, the radar chart shows subscores for a first dataset, a second dataset, a best-in-class dataset, and an industry average dataset (e.g., a composite of the subscores for datasets within an industry). In some embodiments, the radar chart area 702 (or another part of the user interface 700) can include options that allow the user to select which subscores are shown in the radar chart area 702. For example, there can be many subscores, and presenting all of the subscores at the same time could be confusing or difficult to interpret, so users may find it desirable to select only subsets of subscores to display in the radar chart area 702.

The user interface 700 can include a data selector area 704. The data selector area 704 can include user interface elements such as dropdowns, text boxes, and so forth. In some embodiments, when a user begins entering information into a text box in the data selector area 704, a system can trigger a search and can provide results for datasets that match the entered text. For example, if a user enters the name of a company, the system may return results showing datasets associated with the company. While two inputs are illustrated in FIG. 7, in some embodiments, there may be more than two inputs. In some embodiments, there can be, for example, a button that enables a user to add additional inputs (for example, if a user wanted to compare three datasets).

The user interface 700 can include a data selector 706. The data selector 706 can be used to help visualize changes in a dataset over time. For example, a user may wish to compare how a dataset compared to other industry datasets in the past and how the dataset compares at a different date (for example, the present or another, different date in the past).

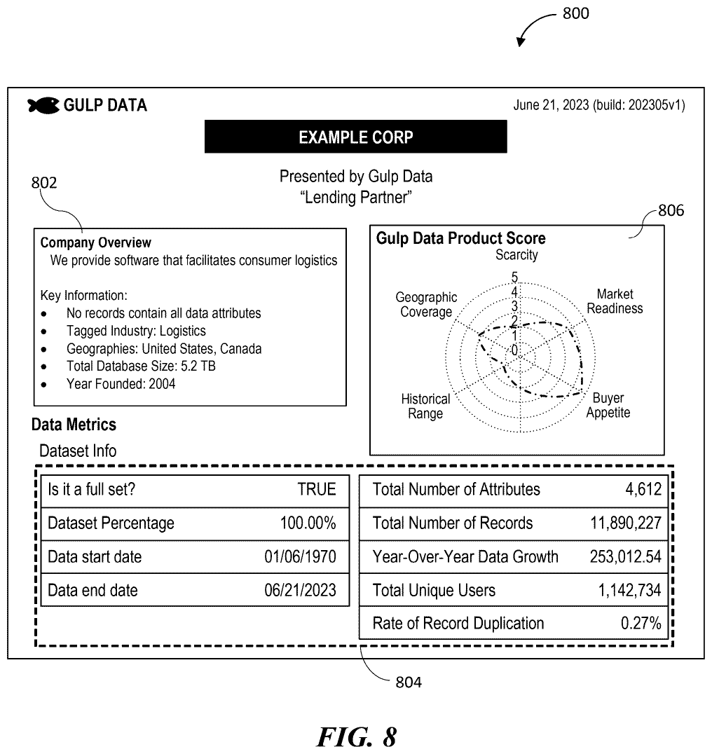

FIG. 8 illustrates an example report according to some embodiments. In FIG. 8, the report 800 includes information such as a company overview 802, data metrics 804, and a radar chart 806.

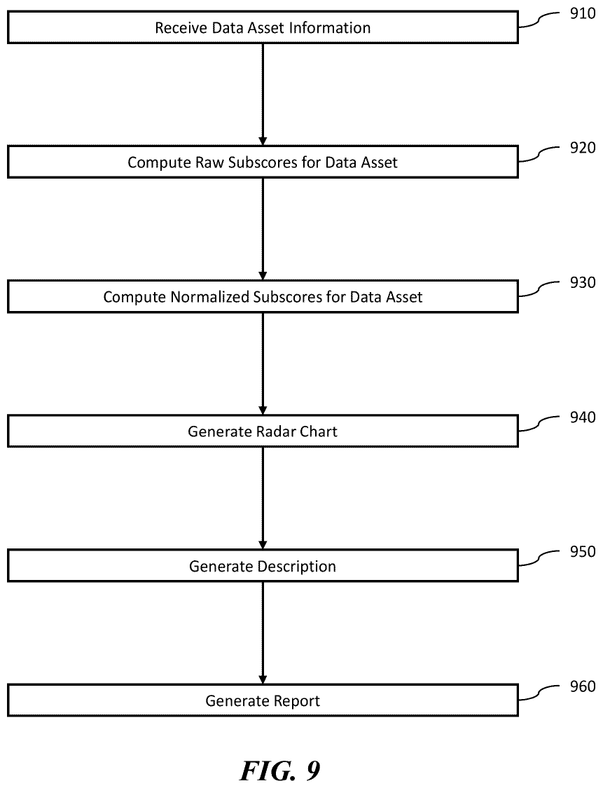

FIG. 9 is a flow chart that illustrates an example subscoring process according to some embodiments. The process illustrated in FIG. 9 can be performed by a computing system. At step 910, the system can receive dataset information, for example a summary of data as described herein. At step 920, the system can, using the dataset information, compute one or more raw subscores for the dataset (e.g., a score based on number of records in the dataset, completeness of the records, timespan of the records, freshness of the records, growth rate of the dataset, number of market-ready attributes, and so forth). In some embodiments, a raw subscore can be a score corresponding to a particular metric (e.g., number of records). In some embodiments, a raw subscore can be the metric itself (e.g., a raw subscore for number of records can be the total number of records in the dataset). At step 930, the system can compute one or more normalized subscores for the dataset. Each normalized subscore can be limited to a restricted set of values (e.g., between 1 and 100, between 0 and 5, and a letter rating, and so forth). In some embodiments, the normalized subscore can be a relative measure of the raw subscore of the dataset as compared with other datasets that have been evaluated. In some embodiments, the process can terminate or pause after step 930. For example, further steps may be executed in response to receiving a user input, such as a request for a report or a request to view a web page providing a user interface for displaying and/or manipulating a radar chart. At step 940, the system can generate one or more radar charts. As described herein, there can be many subscores. Accordingly, it can be significant to provide multiple radar charts so that data can be presented in an easily digestible manner. At step 950, the system can generate descriptions and/or other language for a report, web page, etc. For example, in some embodiments, a large language model (LLM) can be used to generate text such as a written summary of a valuation, a brief description of the company and/or industry, a description of trends within an industry, and so forth. At step 960, the system can generate a report and/or a web page. In some embodiments, a report may be presented in the form of a web page, PDF, word processing document, spreadsheet, etc. In some embodiments, the report can be interactive, such as by providing a user interface as shown in FIG. 7 that enables a user to customize radar graphs.

In some embodiments, value scores, radar charts, and so forth can be used as a pre-sales tool, for example to help show potential clients the benefits of dataset valuation services. In some cases, consultants and other professionals can use value scores, radar charts, and so forth to help convert their clients to larger contracts. For example, the value scores, radar charts, and so forth can be used to show clients deficiencies in their datasets, and a consultant may subsequently enter into a contract to improve the dataset.

### Product Recommendations

A client's data may have a large number of attributes. However, not all attributes are of the same value. Some attributes may be of high interest to potential buyers, while other attributes may be of little or no interest to potential buyers. Typically, when data is sold, only a subset of attributes are bundled together. For example, data that is sold can include less than about 10, less than about 20, less than about 30, less than about 40, less than about 50, etc. For example, buyers may only be interested in attributes that can be readily used by the buyer and may not be interested in other attributes that are of little or no use.

In some embodiments, a data valuation platform can be configured to recommend bundles of attributes that may be of significant interest to potential buyers. For example, bundles can include attributes that are commonly purchased on marketplaces.

In some embodiments, products can be based on categorization of a dataset. This can offer some advantages, as a platform can have a high degree of control of the categories of datasets and the possible results of categorization. Additionally, a platform can improve the categorization over time using internal knowledge, customer feedback, etc. For example, a platform can combine categories, split categories, and so forth. However, such an approach can make it difficult to customize product recommendations on a per-client basis. For example, such an approach may consider how a dataset is categorized, but may not consider the specific attributes within a dataset.

In some embodiments, a large language model can be used as part of a process for determining product recommendations. For example, a large language model can be provided with a list of attributes of a dataset, and the large language model can be asked to output one or more categories for the dataset. Such an approach can be beneficial because, for example, product recommendations can be highly customers based on attributes in a dataset. However, such an approach can limit control over the results, may introduce dependence on an external tool, can break when there are many attributes, and so forth.

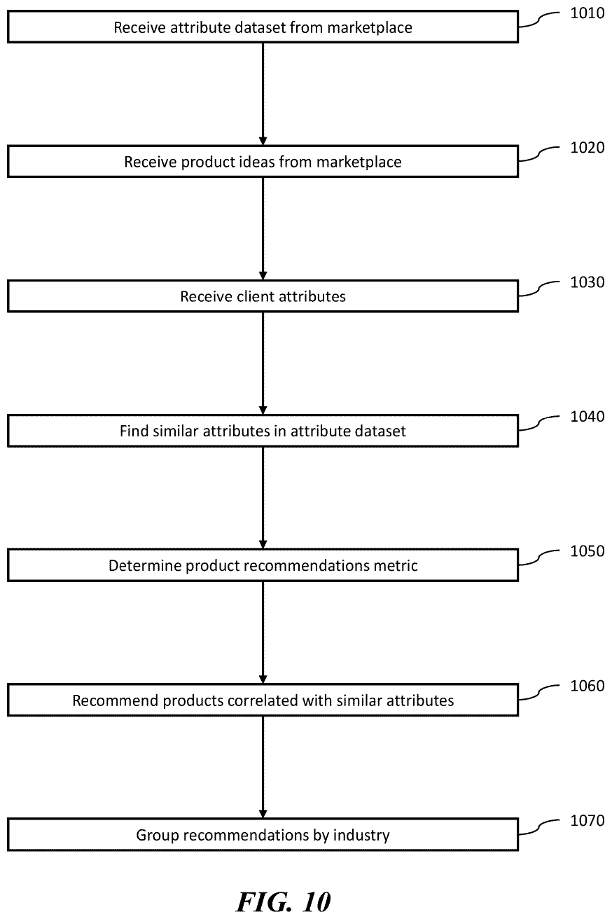

FIG. 10 is a flowchart that illustrates an example process for bundling attributes in a dataset according to some embodiments.

At step 1010, a system can receive an attribute dataset from a marketplace. The attribute dataset can include, for example, attributes of datasets that were sold. At step 1020, the system can receive product ideas from the marketplace. For example, product ideas can include data indicating which attributes are commonly bundled, which industries have an interest in particular types of data, and so forth. At step 1030, the system can receive attributes of a client dataset. At step 1040, the system can find similar attributes in the attribute dataset. At step 1050, the system can determine product recommendations metrics. For example, a product recommendations metric may be higher for a product (e.g., a bundle of attributes) that is of high interest to buyers. At step 1060, the system can recommend products correlated with similar attributes. For example, if the marketplace data shows that a product that includes name, email address, and income is of high value, the system can recommend that the client offer a product that includes name, email address, and income. In some cases, the client's data may not have exactly the same attributes as data that has previously sold on the marketplace but may have attributes that are similar to those found in high value datasets.

At step 1070, the system can group recommendations by industry. For example, the system may determine that a first bundle is of significant interest to consumer goods companies, while second bundle is of significant interest to those in the logistics industry.

### Buyer Recommendations

While data can be of significant value, it can be difficult for clients to identify potential buyers for the data. For example, buyers may not know which companies may be interested in their data, may not know which data brokers or aggregators are interested in the types of data of the client has, and so forth. Thus, in some embodiments, it can be significant to identify potential buyers for the client's data.

Determining buyers can be complicated by the fact that, while a client's data may have a large number of attributes (for example, hundreds or even thousands of attributes), data that is bought and sold typically only comprises a handful of attributes, for example less than about 10, less than about 20, less than about 30, less than about 40, less than about 50, etc. For example, buyers may only be interested in attributes that can be readily used by the buyer and may not be interested in other attributes that are of little or no use. For example, a consumer goods retailer may be interested in data that can be used to determine regions in which the retailer may wish to expand (e.g., median income, same store sales, number of customers, etc.), but may not be interested in data such as customer rewards numbers, customer birthdays, particular items purchased, etc. For example, a luxury retailer of clothing may want to know how other dealers in high end goods such as clothing, home furnishings, art, etc., are doing in a particular geographic area. However, the luxury retailer may not care whether someone bought a couch or a coffee table.

When buyers are also sellers of data (e.g., a buyer who is a broker of data or reseller of data), sales by a buyer can be used to determine types of data, attributes, etc., that a buyer may be interested in purchasing. In some embodiments, dataset listings on one or more marketplaces can be scraped continuously or periodically to determine the types of data that buyers are selling, how much they are selling data for, and so forth. This information can be used to help identify potential buyers of an entity's datasets. For example, such information can be used as inputs into a machine learning model.

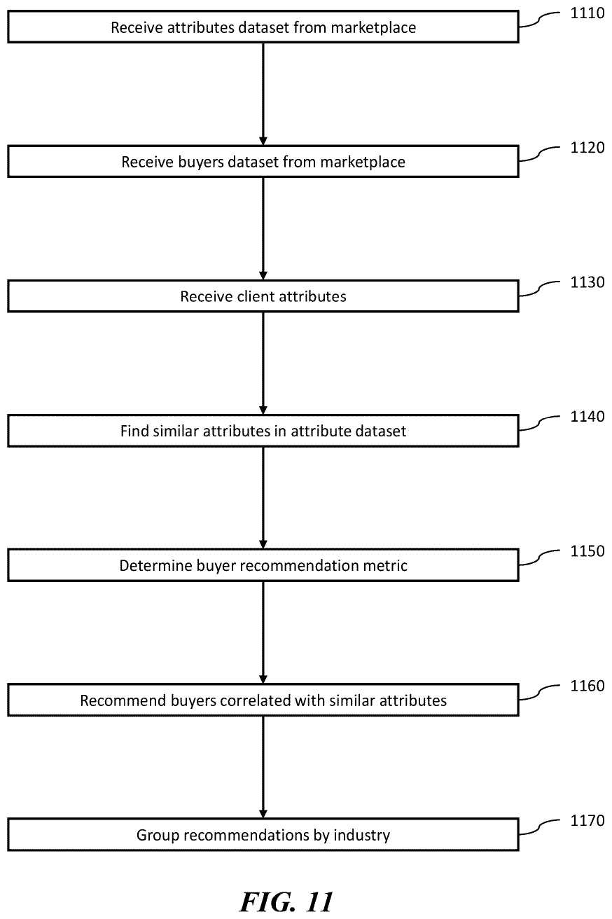

FIG. 11 is a flowchart that illustrates an example process for identifying buyers according to some embodiments. At step 1110, a system can receive an attributes dataset from a marketplace data store. At step 1120, the system can receive a buyers dataset from the marketplace data store. The buyers dataset can identify the buyers of particular datasets. At step 1130, the system can receive attributes for a client's dataset. At step 1140, the system can find similar attributes in the attribute dataset. At step 1150, the system can determine buyer recommendation metrics for the buyers in the buyers dataset. The buyer recommendation metrics can provide a measure of how likely a particular buyer is to be interested in a particular product offered by the client. At step 1160, the system can recommend buyers correlated with similar attributes, e.g., buyers who have previously purchased data with similar attributes. At step 1170, in some embodiments, the system can group recommendations by industry. For example, buyers may be grouped into data brokers, consumer goods companies, information technology companies, advertising companies, shipping companies, and so forth. Such groupings can help a client identify groups that may be particularly interested in the client's data.

In some cases, buyer recommendations can be ranked based on a likelihood that the buyer would buy the client's data. However, such an approach may have some drawbacks. For example, such an approach may rank data brokers and related intermediaries highest, as they may make the most data purchases. However, they may not offer the highest price for a client's data. In some embodiments, potential buyers can be ranked based on an amount that the buyer is likely to pay. In some embodiments, the system can provide functionality that enables the client to prioritize price, days on market (e.g., a client may prefer a quick sale at a lower price or a slower sale at a higher price), etc. For example, a client who is not in immediate need of money may let their data stay on a market longer in order to secure a higher sales price, while another client who wants a quick turnaround time may price the data at a level more likely to attract data brokers and other intermediaries who may purchase the data relatively quickly.

### Attribute Recommendations and Attribute Scarcity

As discussed herein, the value of an organization's data can depend on the particular data that the organization collects. Some attributes may be more valuable than others, potential buyers may be less interested in data that is missing certain attributes, and so forth. For example, a retailer may wish to sell data related to its customer loyalty program or may wish to borrow based on the value of its customer loyalty program data. Customer loyalty data may typically include the ages of customers. If the retailer does not collect customer age in the customer loyalty data, the retailer's data may be of lower value than the data collected by other retailers that do have customer age as an attribute.

In some embodiments, a system can be configured to provide attribute recommendations. Attribute recommendations can be, for example, recommendations for additional attributes that could enhance the value of the data. In some cases, attribute recommendations may suggest that one or more attributes not be collected. For example, if a company is collecting and storing particular attributes at a high cost (e.g., a high cost to gather the data, a high cost to store the data, etc.), but the data is of low value to potential buyers of the data, the system may indicate that those particular attributes are of low value. The company may then decide whether to continue collecting those attributes (e.g., because the company itself has a valuable use for the attributes) or to stop collecting the attributes.

The attributes that drive data value can depend on a variety of factors. For example, attributes that are important in the financial sector may be of lesser importance to the retail or transportation sectors. Thus, in some embodiments, it can be beneficial for the system to provide attribute recommendations by industry.

There can be significant direct and/or indirect costs associated with collecting additional attributes. For example, collecting additional attributes can result in more storage space consumption, high computing resource needs, slower performance, and so forth. In some cases, collecting additional attributes may have detrimental effects on various aspects of a company's business. For example, if an online signup form for a web site is overly long or asks for overly detailed or personal information, users may abandon the signup process. In some cases, collecting additional attributes may introduce additional data security, data privacy, and other concerns that may have a significant financial impact on a company.

In some embodiments, an attribute recommendation engine can provide recommended attributes and can provide an estimate of the value of adding the recommended attributes. In some embodiments, the estimated value can depend upon, for example, the number of records in the client's dataset, a likelihood that the client can or will backfill existing records with the additional attributes, etc. In some embodiments, each recommended attribute can have a value associated therewith. A client may, for example, choose to add only the most valuable attribute or attributes while not adding other attributes that may have less impact on the value of the client's data. In some embodiments, the attributes recommendation engine can provide an estimated cost of adding an attribute (for example, based on the cost of obtaining data for the attribute from a marketplace or otherwise obtaining data for the attribute). This can be important because, for example, adding an attribute may increase the value of a client's dataset, but the cost of adding the attribute may outweigh the added value.

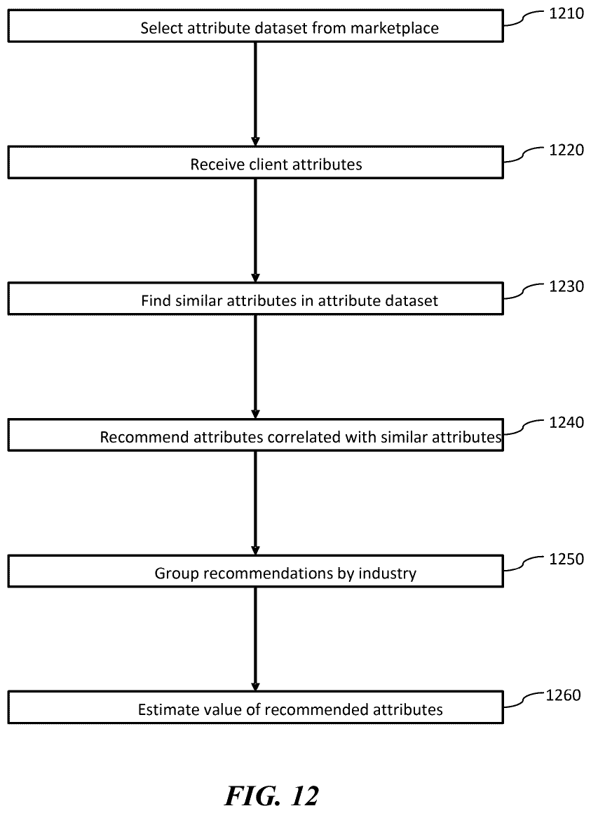

FIG. 12 illustrates an example process for recommended attributes according to some embodiments. The process depicted in FIG. 12 can be performed on a computer system. At step 1210, the system can select an attribute dataset from a marketplace dataset. At step 1220, the system can receive client attributes. For example, the system can extract attributes from data submitted by the client, a data summary submitted by the client (e.g., using an agent as described herein), etc. At step 1230, the system can find attributes in the attribute dataset that are similar to the client attributes. In some embodiments, the system may perform normalization and/or standardization operations on the client attributes and/or on the attributes in the attribute dataset. For example, the system may identify that “name_first” in the client's data is equivalent to “firstName” in the attributes dataset. At step 1240, the system can determine attributes that are correlated with attributes in the attribute dataset that are similar to attributes in the client's data. The system can recommend correlated attributes to the client. At step 1250, the system can group recommendations by industry or category. Industries can include, for example and without limitation, consumer, maritime, media, trade (e.g., shipping), marketing, etc. At step 1260, the system can estimate a value of each attribute. For example, the system can generate a report that shows the value of the adding particular attributes to the client's dataset. In some embodiments, value can be estimated as described above. In some embodiments, estimating the value of adding an attribute can comprise determining a difference between the value of the dataset without the attribute and the value of the dataset with the attribute.

In some cases, there can be attributes that are scarce but nonetheless valuable. For example, an attribute may have high significance within a category but may have low frequency in datasets. In some embodiments, attribute similarity procedures, for example as described herein, can be used to determine categories (e.g., business services, software development, financial services, location data, company data, environmental data, automobiles, insurance, real estate, maritime data, market data, trade data, transportation data, public utility data, etc.) for which attributes may be of high significance. For example, given a list of attributes, a system can be configured to identify categories that have datasets with shared attributes with the attribute list at or over a threshold amount. For example, in some embodiments, attributes can be considered to have high significance within a category if more than 40%, more than 50%, more than 60%, more than 70%, more than 80%, or more or less, or any number between these numbers, of attributes within the attribute list appear in datasets within the category.

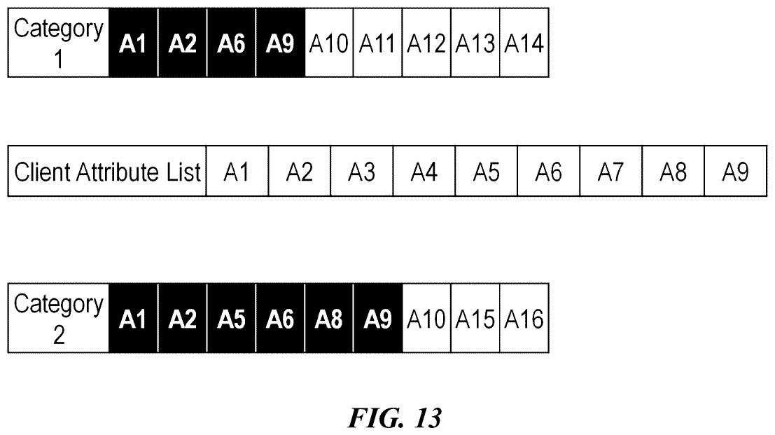

FIG. 13 illustrates an example of high significance determination according to some embodiments. In the following discussion, it is assumed for the sake of simplicity that a threshold metric is that at least 50% of the attributes in a client attribute list should appear within a category in order for that client attribute list to be deemed highly relevant for the category. In FIG. 13, a client attribute list comprises nine attributes A1-A9. Four of the nine attributes (A1, A2, A6, and A9) appear in Category 1. Thus, in some embodiments, the client attribute list may not be considered to be of high value within Category 1 (though this can depend on the chosen threshold). In contrast, six of the nine attributes (A1, A2, A5, A6, A8, and A9) appear in Category 2. Thus, the attribute list may be considered high value for Category 2.

While exact matches for attributes were used in the above discussion of FIG. 13, it will be appreciated that exact attribute matching is not required. Rather, attributes may be considered to match if the attributes have a sufficient similarity at or above a threshold level. For example, Zip+4 and Zip Code can be sufficiently similar.

In addition to selecting categories for which the attribute list is highly significant, it can be significant to determine the scarcity of the attributes within the categories. For example, if an attribute is highly significant but similar attributes appear commonly in datasets within a given category, that attribute may not be considered a scarce attribute (though adding the attribute to a client's dataset may nonetheless be valuable and increase the marketability of the client's data). In some cases, datasets within a category may have no attributes that are similar to an attribute within the attribute list. In some embodiments, such attributes may also be discarded. For example, if there are no datasets with similar attributes in a category, that can indicate that the attribute is not relevant within the category.

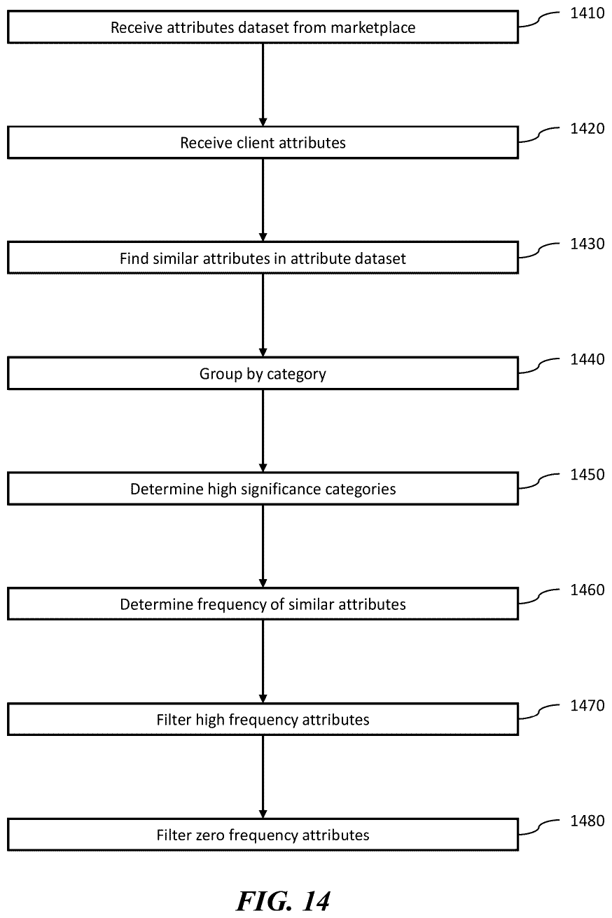

FIG. 14 is a flowchart that illustrates an example scarce attribute identification process according to some embodiments. The process illustrated in FIG. 14 can be performed on a computer system.

At step 1410, the system can receive an attributes dataset from a marketplace data store. The attributes dataset can include an indication of a category for the data associated with each of the attributes in the attributes dataset. At step 1420, the system can receive client attributes. The client attributes can comprise a list of attributes in a client's dataset. In some embodiments, the list of attributes can be a list of all attributes in the client's dataset. In some embodiments, the list of attributes can comprise fewer than all of the attributes in the client's dataset. For example, a subset of attributes can be selected to determine if the certain subsets of attributes contain highly significant but scarce attributes in one or more categories. A subset may comprise, for example and without limitation, geolocation information, shipping information, order information, customer information, device information (e.g., device ID, operating system, operating system version, IMEI, web browser, web browser version, screen resolution, etc.), EXIF data (e.g., camera model, focal length, shutter speed, f-stop, geolocation, etc.), or any other subset of data.

At step 1430, the system can find similar attributes in the attribute dataset. For example, the system can find attributes that store the same or similar information in the attribute dataset. For example, if the client's data has an attribute called “apartmentNumber” and there is an attribute in the attributes dataset called “address2,” the system may determine that these are similar attributes, as both may contain information about an apartment number, suite number, floor number, etc. At step 1440, the system can group the attributes from the attributes data store into categories, for example transport data, consumer data, financial data, healthcare data, automotive data, and so forth. At step 1450, the system can determine highly significant categories. For example, as described above, the system can identify categories with similar metrics having at least a threshold overlap with client attributes or a subset of client attributes. At step 1460, the system can determine the frequency of similar attributes. For example, the system can determine how often similar attributes occur within one or more categories of the attributes dataset. At block 1470, the system can filter high frequency attributes. For example, if a similar attribute appears with more than a threshold frequency in datasets within a particular category (e.g., more than 30%, more than 40%, more than 50%, more than 60%, more than 70%, more than 80%, more than 90%, or any value between these values, or more or less), the system can discard the corresponding client attribute because the client attribute is not scarce within the data for the category. At step 1480, the system can filter zero frequency attributes. That is, for example, the system can discard any client attributes that do not appear at all in the data for the category. In some embodiments, rather than filtering zero frequency attributes, the system can filter attributes that appear with less than a threshold frequency. For example, if only 0.01%, 0.1%, 0.5%, 1%, or any number between the numbers, or more or less) of datasets within a category contain a similar attribute, the corresponding client attribute may nonetheless be irrelevant or of low value for that category.

### Industry and Market Multipliers

Various factors can influence the value of a data set. For example, the industry to which the data set pertains, market conditions, and so forth can impact demand for a data set, and thus can impact the value of a data set. In some embodiments, a platform can consider industry multipliers to adjust the value of a dataset. In some embodiments, a platform can consider market multipliers to adjust the value of a dataset. In some embodiments, a platform can consider both index multipliers and market multipliers, or neither. In some embodiments, a platform can consider other multipliers, such as a regulatory multiplier that adjusts for the value of data based on potential regulatory issues (e.g., if the data contains information about GDPR subjects, residents of states with certain protections (e.g., California Consumer Privacy Act), if the data contains protected health information, and so forth).

In some embodiments, a system can be configured to determine a base value of a dataset. The base value can be a value of the dataset that does not consider market fluctuations, industry fluctuations, etc. In some embodiments, industry multipliers, market multipliers, etc., can be used to account for fluctuations in demand, market conditions, etc., so that the value of a dataset can reflect a current value. In some embodiments, using market multipliers, industry multipliers, etc., can enable a system to determine a current value of a dataset without having to fully redetermine the value of the dataset. For example, the base value can be adjusted up or down based on one or more multipliers to determine a current value of the dataset.

In some embodiments, an industry multiplier can be determined to adjust the value of a dataset. For example, demand may be high or low in a particular industry, supply may be high or low in a particular industry, etc. For example, demand may be relatively low in a certain industry, in which case the value of a dataset can be reduced, or demand may be relatively high in an industry, in which case the value of a dataset can be reduced. In some cases, overall market demand can be high or low. For example, during a recession or other economic downturn, the demand for data can be reduced and prices can be lower. During periods of strong economic growth, demand can be relatively high, and prices for datasets can be increased. In some cases, overall market conditions can indicate a multiplier for dataset valuation. In some cases, the overall market conditions may not be reflective of demand for data. For example, while the overall economy can be doing well, there may be periods of reduced demand for data. When the overall economy is doing poorly, in some cases there may be an increase in demand for data, for example as businesses seek to acquire data to identify potential customers.

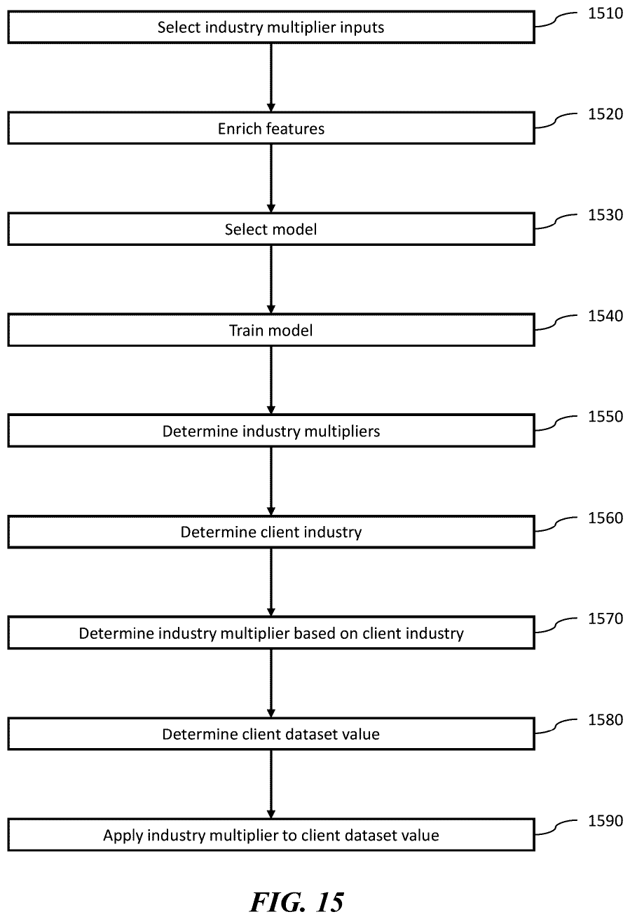

FIG. 15 is a flowchart that illustrates an example process for determining and applying industry multipliers according to some embodiments. The process depicted in FIG. 15 can be performed on a computer system. In some embodiments, different portions of the process depicted in FIG. 15 can be performed on different computers, at different times, etc. For example, training can be performed on a first computer system at a first time, and the trained model can be applied using a second computer system at a second time. The first computer system and the second computer system can be the same system or can be different systems.

At step 1510, the system can select industry multiplier inputs. The industry multiplier inputs can relate to demand, pricing, etc., of data related to a particular industry. At step 1520, the system can enrich features determined from the industry multiplier inputs, for example to normalize the inputs, add additional information to the inputs, and so forth. At step 1530, the system can select a machine learning model. At step 1540, the system can train the machine learning model, for example using a price or industry multiplier as an output and industry multiplier inputs as inputs to the model. At step 1550, the system can determine industry multipliers. At step 1560, the system can determine an industry for a client dataset. In some cases, the system can determine more than one industry. For example, a dataset may be relevant to both social media and consumer goods. At step 1570, the system can determine an industry multiplier based on the identified industry. At step 1580, the system can determine a value of the client's dataset (e.g., a value determined as described herein), which in some embodiments may not include an industry multiplier. At step 1590, the system can apply the determined industry multiplier to determine a value of the dataset that considers the industry applicable to the dataset.

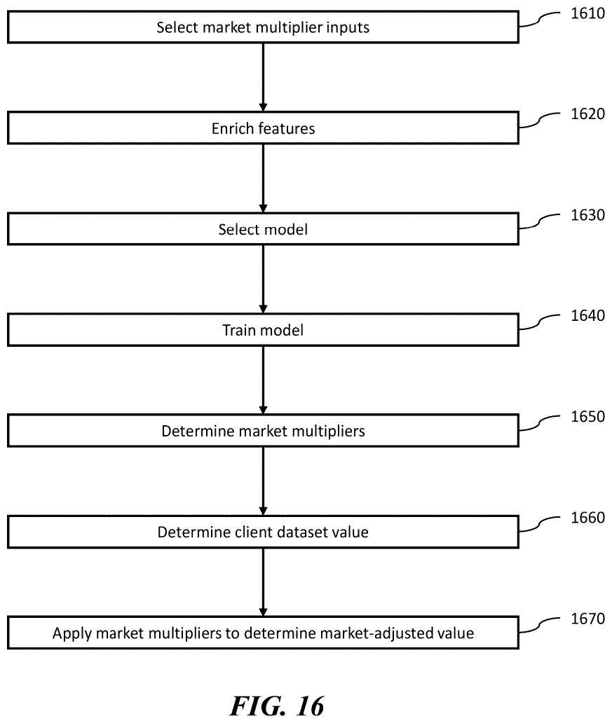

FIG. 16 is a flowchart that illustrates an example process for determining and applying market multipliers according to some embodiments. The process depicted in FIG. 16 can be performed on a computer system. In some embodiments, different portions of the process depicted in FIG. 16 can be performed on different computers, at different times, etc. For example, training can be performed on a first computer system at a first time, and the trained model can be applied using a second computer system at a second time. The first computer system and the second computer system can be the same system or can be different systems.

At step 1610, the system can select market multiplier inputs. Market multiplier inputs can include, for example, stock index data (e.g., NASDAQ, DOW JONES, S&P 500, etc.), a consumer confidence index, a consumer products demand index, a consumer products inflation index, exchange traded funds (ETF), fictional funds (e.g., a combination of publicly traded stocks, funds, etc.), and so forth. In some embodiments, an ETF can be a diversified ETF. In some embodiments, an ETF can be more focused, for example an ETF that tracks cloud computing companies, data brokers, etc. In some embodiments, market multiplier inputs can include a data price index. The data price index can be an index that is based on regional, national, global, etc., market data reflective of the sales prices for data on the open market. In some embodiments, the data price index can, additionally or alternatively, use private sales data. In some embodiments, private sales data can be obtained through agreements with companies that engage in data sales on private markets.

At step 1620, the system can enrich one or more features. At step 1630, the system can select one or more models for training. At step 1640, the system can train the one or more models. The market multiplier inputs can be used as the basis for the input data for training the model. For example, feature vectors can be generated based on the market multiplier inputs, and the feature vectors can be inputs to the model. The model can be trained in a supervised manner. For example, market multipliers can be the outputs of the model, and the model weights can be adjusted to produce a given set of market multipliers associated with the market multiplier inputs. At step 1650, the system can determine market multipliers. For example, current market data can be provided to the trained model and the model can output one or more market multipliers. At step 1660, the system can determine a client dataset value. At step 1670, the system can apply one or more market multipliers to determine a market-adjusted value of the dataset.

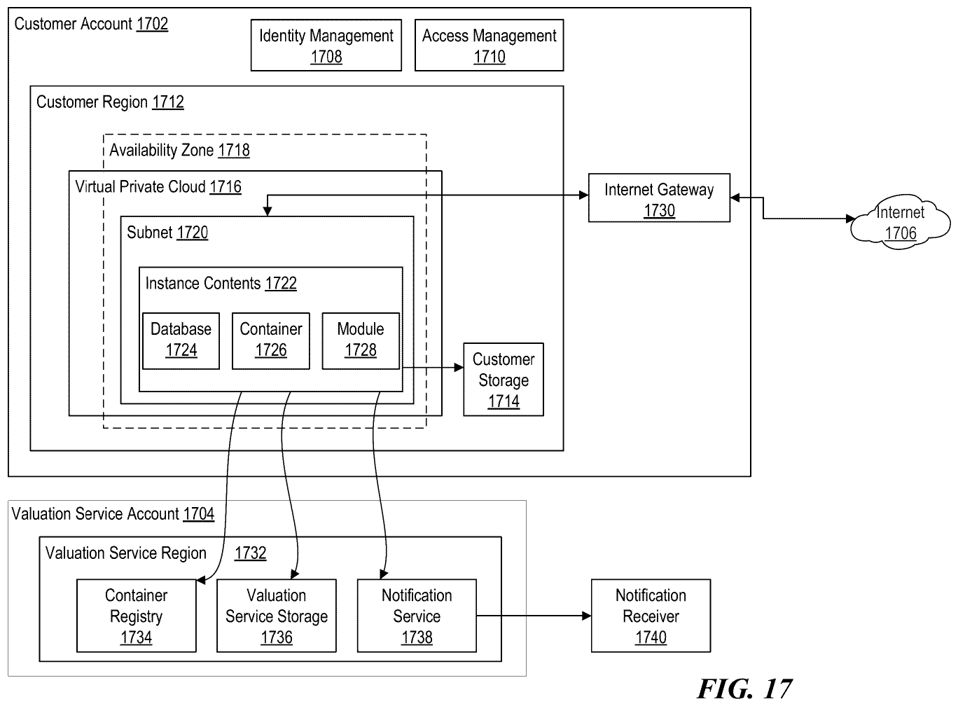

FIG. 17 is a schematic diagram that illustrates various components and information transmission pathways between a customer (also referred to herein as a client) and a valuation service (which could also be a lending service, sales platform, etc.). In FIG. 17, it is anticipated that the customer and valuation service each use a cloud platform, although it will be appreciated that other configurations are possible, such as hybrid configurations (e.g., a combination of cloud and local computing/storage), local configurations (e.g., in which a customer, valuation service, or both store data, perform computing tasks, or both locally).

As shown in FIG. 17 a customer account 1702 and valuation service account 1704 can communicate with one another. The customer account 1702 can be connected to the internet 1706. In some embodiments, the valuation service account 1704 can be connected to the internet 1706. In some embodiments, data transfers between the customer account 1702 and valuation service account 1704 can take place over the internet 1706. In some embodiments, data transfers between the customer account 1702 and the valuation service account 1704 can take place over a local network, wide area network, etc., for example in cases where the customer account 1702 and the valuation service account 1704 are hosted on the same cloud service. The customer account 1702 can use identity management 1708 and access management 1710 to ensure that only authorized users have access to the customer's information and to control the access of individual user accounts to the customer's data. The customer account 1702 can include a customer region 1712. The customer region 1712 can be a geographic region where the customer's data and other compute resources are located. Within a customer region 1712, there can be one or more availability zones. For example, a cloud computing provider may have one or more locations in a geographic region (e.g., a cloud provider may have a “US West” location that includes data centers located in California, Oregon, and Washington). The customer can operate a virtual private cloud 1716 within an availability zone 1718. The virtual private cloud 1716 can include one or more subnets. Within the subnet 1720, the customer can maintain instance contents 1722, which can include, for example, a database 1724, containers 1726, and/or other modules 1728. In some embodiments, customer storage 1714 can be inside the virtual private cloud 1716. In some embodiments, as shown in FIG. 17, the customer storage 1714 can be located outside the virtual private cloud 1716 and within the customer region 1712. In some embodiments, an internet gateway 1730 can connect the subnet 1720 to the internet 1706.

The valuation service account 1704 can include a valuation service region 1732, which can be the same region or a different region than the customer region 1712. Within the valuation service region 1732, the valuation service account 1704 can include a container registry 1734, valuation service storage 1736, and a notification service 1738. In some embodiments, the valuation service region 1732 can include additional and/or different modules. In some embodiments, the notification service 1738 can be configured to send notifications to a notification receiver 1740. The notification receiver 1740 can be, for example, a customer relationship management platform, an email platform, a chat platform, etc.

### Data Escrow and Data Integrity

As described herein, in some embodiments, an entity can upload data over time to a platform. It can be important to ensure that the uploaded data is accurate, complete, etc. In some embodiments, a platform can be configured to perform iterative checks. In some embodiments, iterative checks can be used to periodically examine stored datasets to assess them for consistency, completeness, growth, compliance with predefined criteria, and so forth. In some embodiments, the platform can check for unusual deletions, unusually large volumes of new records, unexpected modifications to a dataset, and so forth.

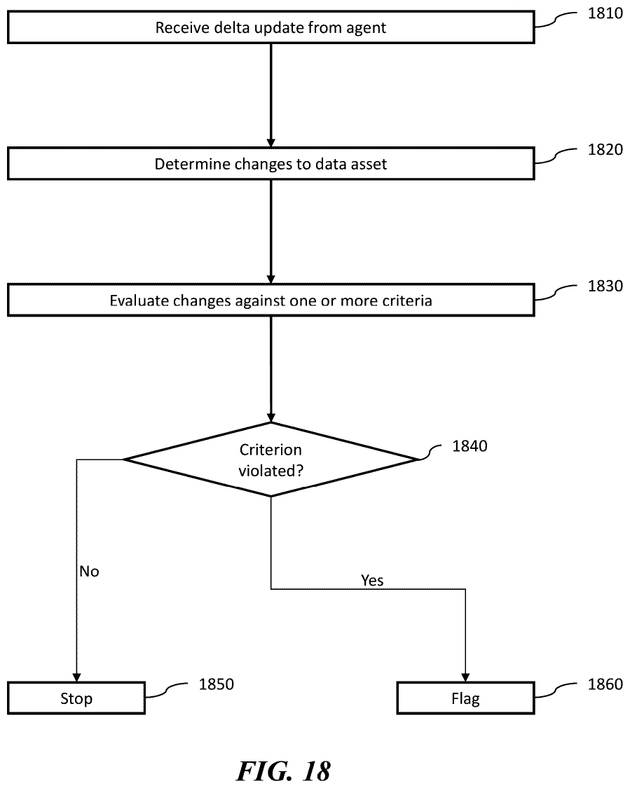

FIG. 18 is a flowchart that illustrates an example data integrity check process according to some embodiments. The data integrity check process can be performed on a computer system. At step 1810, the system can receive a delta update from an agent running on an entity's computing environment. At step 1820, the system can analyze the delta update to determine changes to a dataset. The changes can include, for example, creations, updates, deletions, or any combination thereof. At step 1830, the system can evaluate the changes against one or more criteria. The criteria can include, for example, the creation of records above a threshold value, the modification of existing records above a threshold value, the deletion of records above a threshold value, the creation of records below a threshold value, and so forth. For example, creation of records above a threshold value can indicate that the entity is provided erroneous new records, which could be the result of a cyberattack, intentional manipulation by the entity, etc. Modification or deletion of existing records above a threshold amount could indicate a cyberattack (e.g., an attacker attempting to corrupt or delete existing data), an attempt by the entity to conceal information, etc. Additions below a threshold could indicate a problem with a process for determining the delta, a problem creating new records in a database, a cyberattack, intentional concealment of new records, etc. In some embodiments, threshold values can depend on the entity. For example, a large entity can be expected to have a greater number of creations, updates, and deletions than a smaller entity. In some embodiments, thresholds can be seasonally adjusted. For example, an online retailer may expect to create a large number of records during the holiday shopping season.

At step 1840, the system can determine if one or more criteria were violated. If not, the verification process can stop at step 1850. In some embodiments, the delta update can be flagged as having passed the data integrity check. If, at step 1840, one or more criteria has been violated, the system can, at step 1860, flag the delta update as potentially problematic, in which case the delta update can undergo further investigation.

### Buyer Facilitation

Much of the discussion above is directed to helping sellers and borrowers improve their datasets, market their datasets, and so forth. In some embodiments, the systems and methods herein can facilitate buyer activities alternatively or additionally. For example, a buyer may know what kind of data they are looking for, but locating a suitable seller of that data can prove difficult. For example, attribute names can be inconsistent from seller to seller, data may be organized differently from seller to seller, different sellers may collect different information that can represent the same or similar information (e.g., one seller might store zip code while another might store city and state).

As described herein, in some embodiments, an LLM can be used to generate descriptions of a dataset and/or the attributes included therein. Such descriptions can enable buyers and/or brokers to search for datasets that contain attributes of interest, which are sourced from particular industries, which come from particular geographic locations, and so forth.

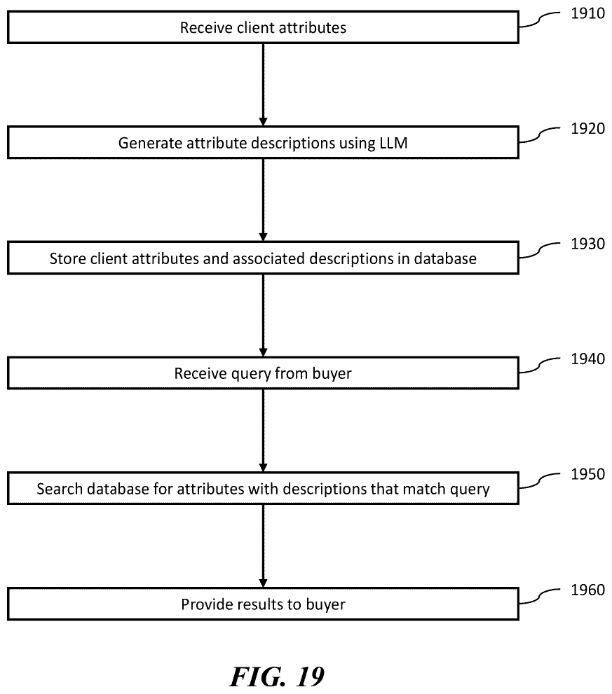

FIG. 19 is a flowchart that illustrates an example process that can be used to enable natural text searching of datasets. The process of FIG. 19 can be performed on a computing system. At step 1910, the system can receive client attributes, for example as described herein. The client attributes can be attributes of a dataset that a client wishes to sell or otherwise provide access to. At step 1920, the system can generate attribute descriptions using an LLM or another AI/ML model. At step 1930, the system can store the client attributes and associated descriptions in a database. At step 1940, the system can receive a query from a buyer or broker. The query can include natural text such as, for example, “home address” or “last name.” At step 1950, the system can search the database for attributes that have descriptions matching the query. In some embodiments, the system may only search the descriptions. In some embodiments, the system can search both the attributes and the descriptions. At step 1960, the system can provide search results to the buyer or broker. In some embodiments, the search results can be ranked. For example, the system can rank datasets that most closely match the buyer or broker's query higher than datasets that are poor matches. As one example, if a query includes five attributes, a dataset that includes four of the five attributes can be ranked higher than a dataset that includes only two of the five attributes. Ranking can be influenced by scores such as the value score and/or the subscores described herein. For example, a dataset with a high value score may generally rank higher than a dataset with a lower value score, although in some cases this may not be the case, for example when a dataset with a higher value score does not match the query as well as a dataset with a lower value score.

### Machine Learning

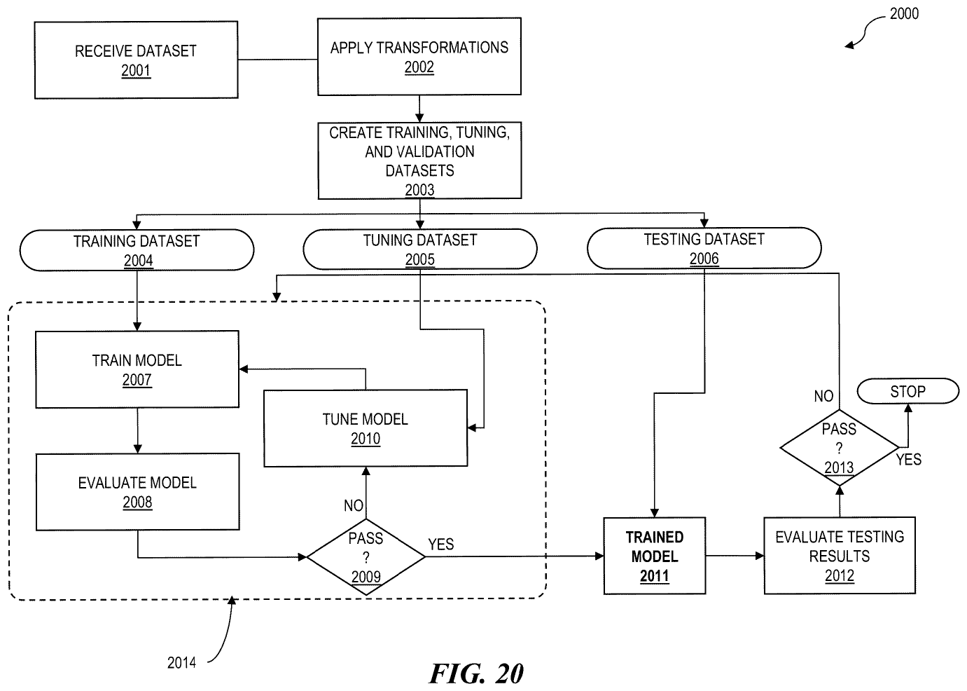

FIG. 20 depicts a process for training an artificial intelligence or machine learning model according to some embodiments. The process 2000 can be run on a computing system. At block 2001, the system may access or receive a dataset. The dataset may include for example, dataset summaries, dataset analyses, dataset valuations, dataset sale prices, and so forth. At block 2002, the samples can be parsed. Parsing can include, for example, extracting strings, extracting metadata, processing registry files, etc. In some embodiments, one or more transformations can be applied to the extracted data. For example, data may require transformations to conform to expected input formats, for example to conform with expected date and/or time formatting. Strings and/or other information may be modified prior to use in machine learning training. For example, categorical data may be encoded in a particular manner. Nominal data may be encoded using one-hot encoding, binary encoding, feature hashing, or other suitable encoding methods. Ordinal data may be encoded using ordinal encoding, polynomial encoding, Helmert encoding, and so forth. Numerical data may be normalized, for example by scaling data to a maximum of 1 and a minimum of 0 or −1. These are merely examples, and the skilled artisan will readily appreciate that other transformations are possible. At block 2003, the system may create, from the received dataset, training, tuning, and testing/validation datasets. The training dataset 2004 may be used during training to determine features for forming a predictive model. The tuning dataset 2005 may be used to select final models and to prevent or correct overfitting that may occur during training with the training dataset 2004, as the trained model should be generally applicable to a broad range of input data, not merely to data used for model training. The testing dataset 2006 may be used after training and tuning to evaluate the model. For example, the testing dataset 2006 may be used to check if the model is overfitted to the training dataset. The system, in training loop 2014, may train the model at block 2007 using the training dataset 2004. Training may be conducted in a supervised, unsupervised, or partially supervised manner. According to various embodiments herein, models can be trained in a supervised manner. At 2008, the system may evaluate the model according to one or more evaluation criteria. For example, the evaluation may include determining how often a model for predicting dataset value accurately predicts the value for which a dataset sold. At decision point 2009, the system may determine if the model meets the one or more evaluation criteria. If the model fails evaluation, the system may, at 2010, tune the model using the tuning dataset 2005, repeating the training block 2007 and evaluation 2008 until the model passes the evaluation at decision point 2009. Once the model passes the evaluation at 2009, the system may exit the model training loop 2014. The testing dataset 2006 may be run through the trained model 2011 and, at block 2012, the system may evaluate the results. If the evaluation fails, at block 2013, the system may reenter training loop 2014 for additional training and tuning. If the model passes, the system may stop the training process, resulting in a trained model 2011. In some embodiments, the training process may be modified. For example, the system may not use a tuning dataset 2005. In some embodiments, the model may not use a testing dataset 2006.

### Computer Systems

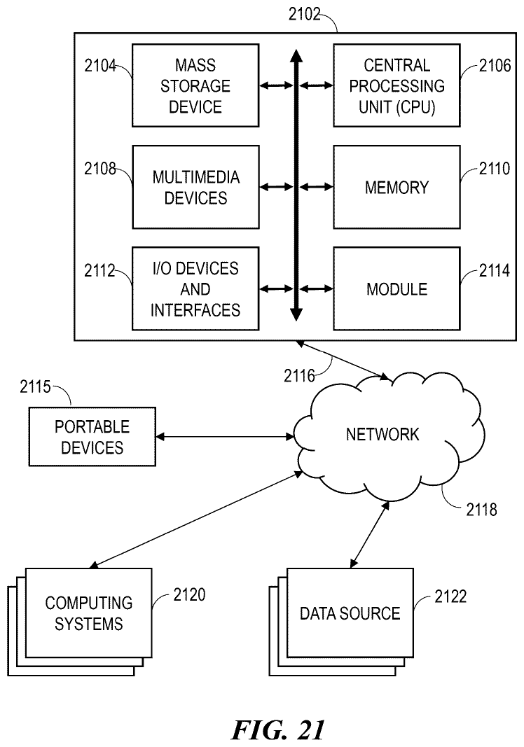

FIG. 21 is a block diagram depicting an embodiment of a computer hardware system configured to run software for implementing one or more embodiments disclosed herein.

In some embodiments, the systems, processes, and methods described herein are implemented using a computing system, such as the one illustrated in FIG. 21. The example computer system 2102 is in communication with one or more computing systems 2120 and/or one or more data sources 2122 via one or more networks 2118. While FIG. 21 illustrates an embodiment of a computing system 2102, it is recognized that the functionality provided for in the components and modules of computer system 2102 may be combined into fewer components and modules, or further separated into additional components and modules.

The computer system 2102 can comprise a module 2114 that carries out the functions, methods, acts, and/or processes described herein. The module 2114 is executed on the computer system 2102 by a central processing unit 2106 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 2102 includes one or more processing units (CPU) 2106, which may comprise a microprocessor. The computer system 2102 further includes a physical memory 2110, such as random-access memory (RAM) for temporary storage of information, a read only memory (ROM) for permanent storage of information, and a mass storage device 2104, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 2102 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 2102 includes one or more input/output (I/O) devices and interfaces 2112, such as a keyboard, mouse, touch pad, and printer. The I/O devices and interfaces 2112 can include one or more display devices, such as a monitor, which allows the visual presentation of data to a user. More particularly, a display device provides for the presentation of GUIs as application software data, and multi-media presentations, for example. The I/O devices and interfaces 2112 can also provide a communications interface to various external devices. The computer system 2102 may comprise one or more multi-media devices 2108, such as speakers, video cards, graphics accelerators, and microphones, for example.

The computer system 2102 may run on a variety of computing devices, such as a server, a Windows server, a Structure Query Language server, a Unix Server, a personal computer, a laptop computer, and so forth. In other embodiments, the computer system 2102 may run on a cluster computer system, a mainframe computer system and/or other computing system suitable for controlling and/or communicating with large databases, performing high volume transaction processing, and generating reports from large databases. The computing system 2102 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 2102 illustrated in FIG. 21 is coupled to a network 2118, such as a LAN, WAN, or the Internet via a communication link 2116 (wired, wireless, or a combination thereof). Network 2118 communicates with various computing devices and/or other electronic devices. Network 2118 is communicating with one or more computing systems 2120 and one or more data sources 2122. The module 2114 may access or may be accessed by computing systems 2120 and/or data sources 2122 through a web-enabled user access point. Connections may be a direct physical connection, a virtual connection, and other connection type. The web-enabled user access point may comprise a browser module that uses text, graphics, audio, video, and other media to present data and to allow interaction with data via the network 2118.

Access to the module 2114 of the computer system 2102 by computing systems 2120 and/or by data sources 2122 may be through a web-enabled user access point such as the computing systems' 2120 or data source's 2122 personal computer, cellular phone, smartphone, laptop, tablet computer, e-reader device, audio player, or another device capable of connecting to the network 2118. Such a device may have a browser module that is implemented as a module that uses text, graphics, audio, video, and other media to present data and to allow interaction with data via the network 2118.

The output module may be implemented as a combination of an all-points addressable display such as a cathode ray tube (CRT), a liquid crystal display (LCD), a plasma display, or other types and/or combinations of displays. The output module may be implemented to communicate with input devices 2112 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 2102 may comprise a physical or logical connection established between a remote microprocessor and a mainframe host computer for the express purpose of uploading, downloading, or viewing interactive data and databases on-line in real time. The remote microprocessor may be operated by an entity operating the computer system 2102, including the client server systems or the main server system, an/or may be operated by one or more of the data sources 2122 and/or one or more of the computing systems 2120. In some embodiments, terminal emulation software may be used on the microprocessor for participating in the micro-mainframe link.

In some embodiments, computing systems 2120 who are internal to an entity operating the computer system 2102 may access the module 2114 internally as an application or process run by the CPU 2106.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a web site and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 2102 may include one or more internal and/or external data sources (for example, data sources 2122). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Cache), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or Amazon QLDB), a non-relational database, or a record-based database.

The computer system 2102 may also access one or more databases 2122. The databases 2122 may be stored in a database or data repository. The computer system 2102 may access the one or more databases 2122 through a network 2118 or may directly access the database or data repository through I/O devices and interfaces 2112. The data repository storing the one or more databases 2122 may reside within the computer system 2102.

### Additional Embodiments

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. An electronic agent-based computer system method for analyzing metadata received from an electronic agent operating on a client computing system related to a first dataset accessible by the client computing system, using a machine learning model comprising:
establishing, by a computing system, a secure electronic network connection to the electronic agent running on the client computing system;
receiving, by the computing system, from the electronic agent operating on the client computing system via the secure electronic network connection, metadata related to the first dataset, wherein the electronic agent is configured to access the first dataset to dynamically generate the metadata related to the first dataset, the metadata comprising a plurality of attributes of the first dataset and a summary of the first dataset;
applying, by the computing system, a valuation model to the received metadata, wherein the valuation model comprises a machine learning model that is trained using marketplace data, the marketplace data comprising sales prices of one or more datasets and attributes of one or more datasets, wherein the attributes are used to provide inputs to the machine learning model, and wherein the machine learning model is trained to output the sales prices of the one or more datasets; and
determining, by the computing system based on the applying the valuation model, an estimated value of the first dataset.

2. The method of claim 1, wherein the summary comprises at least one of a number of records in the first dataset, a completeness of the first dataset, a uniqueness of records in the first dataset, a growth rate of records in the first dataset, an average number of records associated with each of a plurality of primary keys identified in the first dataset, or an age of the first dataset.

3. The method of claim 1, further comprising:
receiving, by the computing system, a plurality of product ideas from a marketplace, each product idea comprising a plurality of product attributes;
determining, by the computing system, one or more similar attributes in the attributes of the first dataset and the pluralities of product attributes;
determining, by the computing system, one or more product recommendations based on the determined one or more similar attributes; and
providing, by the computing system, the one or more product recommendations to a client.

4. The method of claim 1, further comprising:
receiving, by the computing system, a plurality of attributes from a marketplace;
determining, by the computing system, one or more similar attributes in the attributes of the first dataset and the plurality of attributes from the marketplace;
determining, by the computing system, correlations between one of more attributes of the plurality of attributes from the marketplace and the one or more similar attributes;
determining, by the computing system based on the correlations, one or more recommended attributes to add to the first dataset;
estimating, by the computing system, one or more values of adding one or more recommended attributes to the first dataset; and
providing, by the computing system, the one or more recommended attributes and the one or more values to a client.

5. The method of claim 1, further comprising:
receiving, by the computing system, a plurality of attributes from a marketplace associated with a plurality of dataset sales;
receiving, by the computing system, a plurality of buyer identifiers associated with the plurality of dataset sales;
determining, by the computing system, one or more similar attributes of the first dataset and the plurality of attributes from the marketplace associated with the plurality of dataset sales;
determining, by the computing system based on the one or more similar attributes and the plurality of buyer identifiers, one or more recommended buyers of the first dataset; and
providing, by the computing system, the one or more recommended buyers to a client.

6. The method of claim 1, further comprising:
receiving, by the computing system, a plurality of attributes from a marketplace associated with a plurality of dataset sales;
determining, by the computing system, one or more similar attributes of the first dataset and the plurality of attributes from the marketplace associated with the plurality of dataset sales;
grouping, by the computing system, the one or more similar attributes into one or more categories;
determining, by the computing system, one or more high significance categories;
determining, by the computing system, one or more frequencies of one or more similar attributes;
removing, by the computing system, one or more high frequency attributes of the one or more similar attributes;
removing, by the computing system, one or more zero frequency attributes of the one or more similar attributes;
identifying, by the computing system, one or more scarce attributes, wherein the one or more scarce attributes having greater than zero frequency and less than high frequency.

7. The method of claim 1, further comprising:
providing, by the computing system to a large language model, the attributes of the first dataset;
generating, by the computing system using the large language model, a description for each of the attributes of the first dataset;
storing, by the computing system, the attributes of the first dataset and the descriptions in a database, wherein in response to a query from a buyer, the computing system is configured to search the database for attributes that match the query and to provide results of the search to the buyer.

8. The method of claim 1, further comprising:
receiving, by the computing system from the agent installed on the client computing system of the client, a copy of the first dataset, wherein the copy is an encrypted copy of the first dataset; and
storing the copy of the first dataset.

9. The method of claim 8, further comprising:
receiving, by the computing system from the agent installed on the client computing system of the client, an update to the first dataset, wherein the update to the first dataset includes a delta update.

10. The method of claim 1, further comprising:
receiving, by the computing system, from the electronic agent operating on the client computing system via the secure electronic network connection, an encrypted copy of the first dataset;
storing the encrypted copy of the first dataset in a first data store; and
storing an encryption key of the encrypted copy in a second data store, the second data store different from the first data store.

11. A computing system for analyzing metadata, received from an electronic agent operating on a client computing system, related to a first dataset accessible by the client computing system, using a machine learning model, the computing system comprising:
a processor; and
a non-volatile memory having instructions embodied thereon that, when executed by the processor, cause the computing system to perform a method comprising:
establishing, by the computing system, a secure electronic network connection to the electronic agent operating on the client computing system;
receiving, by the computing system, from the electronic agent operating on the client computing system via the secure electronic network connection, metadata related to the first dataset, wherein the electronic agent is configured to access the first dataset to dynamically generate the metadata related to the first dataset, the metadata comprising a plurality of attributes of the first dataset and a summary of the first dataset;
applying, by the computing system, a valuation model to the received metadata, wherein the valuation model comprises a machine learning model that is trained using marketplace data, the marketplace data comprising sales prices of one or more datasets and attributes of one or more datasets, wherein the attributes are used to provide inputs to the machine learning model, and wherein the machine learning model is trained to output the sales prices of the one or more datasets; and
determining, by the computing system based on the applying the valuation model, an estimated value of the first dataset.

12. The computing system of claim 11, wherein the summary comprises at least one of a number of records in the first dataset, a completeness of the first dataset, a uniqueness of records in the first dataset, a growth rate of records in the first dataset, an average number of records associated with each of a plurality of primary keys identified in the first dataset, or an age of the first dataset.

13. The computing system of claim 11, wherein the method executed by the processor further comprises:
receiving a plurality of product ideas from a marketplace, each product idea comprising a plurality of product attributes;
determining one or more similar attributes in the attributes of the first dataset and the pluralities of product attributes;
determining one or more product recommendations based on the determined one or more similar attributes; and
providing the one or more product recommendations to a client.

14. The computing system of claim 11, wherein the method executed by the processor further comprises:
receiving a plurality of attributes from a marketplace;
determining one or more similar attributes in the attributes of the first dataset and the plurality of attributes from the marketplace;
determining correlations between one of more attributes of the plurality of attributes from the marketplace and the one or more similar attributes;
determining, based on the correlations, one or more recommended attributes to add to the first dataset;
estimating one or more values of adding one or more recommended attributes to the first dataset; and
providing the one or more recommended attributes and the one or more values to a client.

15. The computing system of claim 11, wherein the method executed by the processor further comprises:
receiving a plurality of attributes from a marketplace associated with a plurality of dataset sales;
receiving a plurality of buyer identifiers associated with the plurality of dataset sales;
determining one or more similar attributes of the first dataset and the plurality of attributes from the marketplace associated with the plurality of dataset sales;
determining, based on the one or more similar attributes and the plurality of buyer identifiers, one or more recommended buyers of the first dataset; and
providing the one or more recommended buyers to a client.

16. The computing system of claim 11, wherein the method executed by the processor further comprises:
receiving a plurality of attributes from a marketplace associated with a plurality of dataset sales;
determining one or more similar attributes of the first dataset and the plurality of attributes from the marketplace associated with the plurality of dataset sales;
grouping the one or more similar attributes into one or more categories;
determining one or more high significance categories;
determining one or more frequencies of one or more similar attributes;
removing one or more high frequency attributes of the one or more similar attributes;
removing one or more zero frequency attributes of the one or more similar attributes;
identifying one or more scarce attributes, wherein the one or more scarce attributes having greater than zero frequency and less than high frequency.

17. The computing system of claim 11, wherein the method executed by the processor further comprises:
providing, to a large language model, the attributes of the first dataset;
generating, using the large language model, a description for each of the attributes of the first dataset;
storing the attributes of the first dataset and the descriptions in a database, wherein in response to a query from a buyer, the computing system is configured to search the database for attributes that match the query and to provide results of the search to the buyer.

18. The computing system of claim 11, wherein the method executed by the processor further comprises:
receiving, by the computing system from the agent installed on the client computing system of the client, a copy of the first dataset, wherein the copy is an encrypted copy of the first dataset; and
storing the copy of the first dataset.

19. The computing system of claim 18, wherein the method executed by the processor further comprises:
receiving, by the computing system from the agent installed on the client computing system of the client, an update to the first dataset, wherein the update to the first dataset includes a delta update.

20. The computing system of claim 11, wherein the method executed by the processor further comprises:
receiving, by the computing system, from the electronic agent operating on the client computing system via the secure electronic network connection, an encrypted copy of the first dataset;
storing the encrypted copy of the first dataset in a first data store; and
storing an encryption key of the encrypted copy in a second data store, the second data store different from the first data store.
